(19) United States
(12) Patent Application Publication
(10) Pub. No.: US 2016/0245986 A1
(43) Pub. Date: Aug. 25, 2016

(54) LIGHT GUIDE ASSEMBLY, HOUSING ASSEMBLY, AND LIGHTING ASSEMBLY INCLUDING SAME

(71) Applicant: Rambus Delaware LLC, Sunnyvale, CA (US)

(72) Inventors: Martin Ligas, Wadsworth, OH (US); Kurt Starkey, Strongsville, OH (US); Todd Winski, Hudson, OH (US); Robert Ezell, Brunswick, OH (US)

(21) Appl. No.: 15/052,081

(22) Filed: Feb. 24, 2016

Related U.S. Application Data
(60) Provisional application No. 62/180,137, filed on Jun. 16, 2015.
(60) Provisional application No. 62/120,517, filed on Feb. 25, 2015.

(51) Int. Cl. F21V 8/00

(52) U.S. Cl. CPC G02B 6/0078; G02B 6/0088; G02B 6/0068

(57) ABSTRACT

A light guide assembly includes light guide segments, each including opposed major surfaces and a light input edge extending in the thickness direction therebetween. One of the light guide segments includes a first side edge surface including one or more side edge surface sections, at least a portion thereof oriented non-parallel to the thickness direction. Another of the light guide segments includes a second side edge surface complimentary to the first side edge surface. The one of the light guide segments is arranged adjacent the another of the light guide segments and abuts the complimentary second side edge surface, the one of the light guide segments variably positionable relative to the another of the light guide segments about an axis parallel to the length direction. A lighting assembly includes the light guide assembly and a housing assembly having housing segments, each associated with one of the respective light guide segments.

### RELATED APPLICATION DATA

This application claims the benefit of U.S. Provisional Patent Application No. 62/120,517, filed Feb. 25, 2015; and claims the benefit of U.S. Provisional Patent Application No. 62/180,137, filed Jun. 16, 2015; the disclosures of which are incorporated herein by reference in their entireties.

### BACKGROUND

Energy efficiency has become an area of interest for energy consuming devices. One class of energy consuming devices is lighting devices. Light emitting diodes (LEDs) show promise as energy efficient light sources for lighting devices, and may be used together with light guides as LED lighting assemblies. But there are issues associated with producing these LED lighting assemblies in various shapes and sizes, for example, in terms of cost, reproducibility, and/or light output distribution.

### BRIEF DESCRIPTION OF THE DRAWINGS

FIG. 1 is a schematic perspective view of an exemplary light guide assembly.

FIG. 2 is a schematic perspective view of an exemplary light guide segment.

FIGS. 3-5 are schematic side views of parts of an exemplary light guide assembly.

FIGS. 6-8 are schematic side views of parts of an exemplary light guide assembly.

FIGS. 9A-9G are schematic side views of parts of exemplary light guide assemblies.

FIGS. 10-12 are schematic top views of parts of exemplary lighting assemblies.

FIG. 13 is a schematic perspective view of parts of an exemplary lighting assembly.

FIG. 14 is a schematic perspective view of an exemplary lighting assembly segment.

FIG. 15 is a schematic view of an exemplary housing segment.

FIG. 16 is a schematic view of an exemplary housing assembly.

FIGS. 17-21 are schematic perspective views of parts of exemplary lighting assemblies.

FIG. 22 is a schematic perspective view of an exemplary lighting assembly segment.

FIGS. 23-29 are schematic perspective views of exemplary lighting assemblies.

FIG. 30 is a schematic perspective view of an exemplary lighting assembly segment.

FIG. 31 is a schematic side view of parts of an exemplary lighting assembly.

FIG. 32 is a schematic top view of the exemplary lighting assembly of FIG. 31.

FIG. 33 is a schematic perspective view of parts of an exemplary lighting assembly.

FIG. 34 is a schematic perspective view of an exemplary lighting assembly segment.

FIG. 35 is a schematic perspective view of parts of an exemplary lighting assembly.

FIG. 36 is a schematic perspective view of an exemplary light guide assembly.

FIGS. 37A-37C are schematic views of an exemplary light guide assembly.

FIGS. 38A-38C are schematic views of an exemplary light guide assembly.

FIG. 39 is a schematic top view of parts of an exemplary lighting assembly.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface (e.g., the major surface).

In accordance with one aspect of the present disclosure, a light guide assembly includes light guide segments, each including: opposed first and second major surfaces extending between a proximal end and a distal end in a length direction, the opposed first and second major surfaces spaced apart from one another in a thickness direction orthogonal to the length direction; and a light input edge extending in the thickness direction between the opposed first and second major surfaces at the proximal end, the first and the second major surfaces configured to propagate light input to the light guide through the light input edge therebetween by total internal reflection. One of the light guide segments includes a first side edge surface extending between the proximal end and distal end and between the opposed first and second major surfaces, the first side edge surface including one or more side edge surface sections, at least a portion of the one or more side edge surface sections oriented non-parallel to the thickness direction. Another of the light guide segments includes a second side edge surface complimentary to the first side edge surface and extending between the proximal end and distal end and between the opposed first and second major surfaces, the second side edge surface including one or more side edge surface sections, at least a portion of the one or more side edge surface sections oriented non-parallel to the thickness direction. The one of the light guide segments is arranged adjacent the another of the light guide segments such that the first side edge surface abuts the complimentary second side edge surface, the one of the light guide segments variably positionable relative to the another of the light guide segments about an axis parallel to the length direction so the light guide assembly curves about the axis parallel to the length direction.

In accordance with another aspect of the present disclosure, a housing assembly includes housing segments, each housing segment directly coupled to an adjacently located one of the housing segments, each housing segment including: a housing main body extending in a width direction between a first end and a second end; a retaining portion configured to retain a light guide segment extending in a length direction orthogonal to the width direction; and at least one coupling member configured to directly couple the housing segment to the adjacently located one of the housing segments. One of the housing segments includes a first coupling member. Another of the housing segments includes a second coupling member configured to directly couple to the first coupling member. The one of the housing segments is directly coupled to the another of the housing segments via the first and second coupling members and are variably positionable relative to each other about an axis parallel to the length direction.

In accordance with another aspect of the present disclosure, a light guide includes: opposed first and second major surfaces extending between a proximal end and a distal end in a length direction, a light input edge extending between the opposed first and second major surfaces at the proximal end of the light guide, the first and the second major surfaces configured to propagate light input to the light guide through the light input edge therebetween by total internal reflection; a transition area at the proximal end of the light guide; and light guide segments extending from the transition area towards the distal end of the light guide, each one of the light guide segments separated from an adjacent one of the light guide segments by a slot extending in a thickness direction either partially or fully through the light guide. The opposed first and second major surfaces at each light guide segment are planar surfaces. The transition area curves about an axis parallel to the length direction.

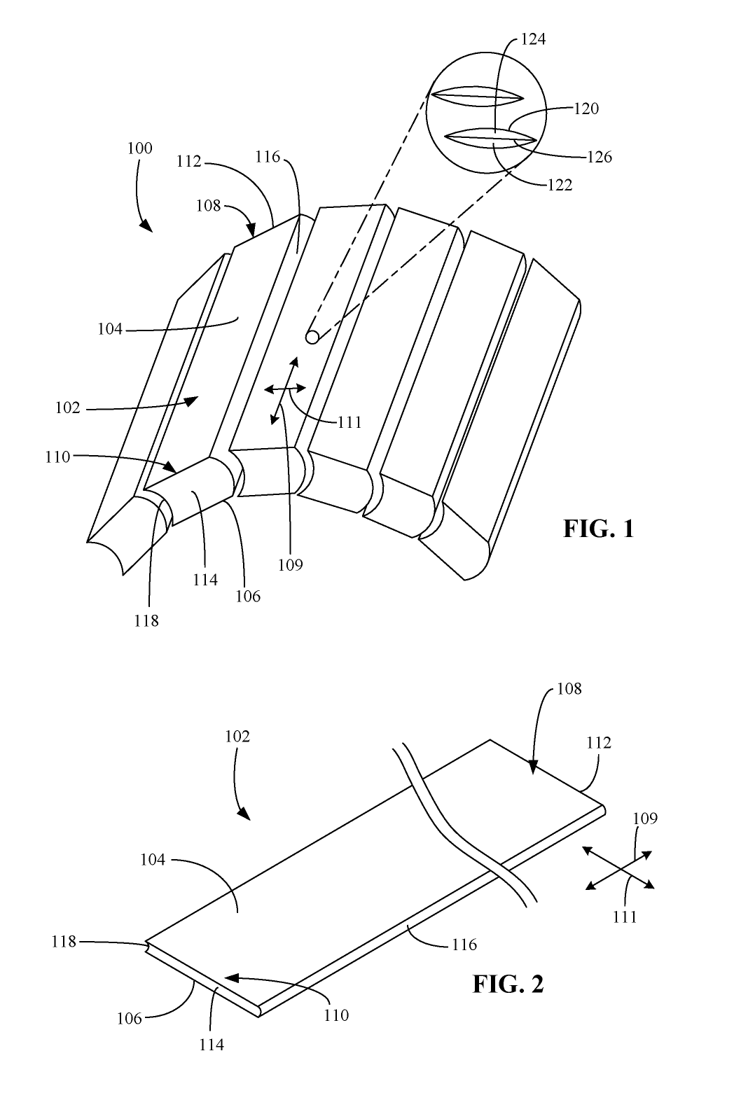

With initial reference to FIG. 1, an exemplary embodiment of a light guide assembly is shown at 100. The light guide assembly 100 includes light guide segments 102, which collectively form the light guide assembly 100. The light guide assembly 100 may also be generally referred to as a light guide. The exemplary light guide assembly 100 shown in FIG. 1 includes six light guide segments 102, but in other embodiments the light guide assembly 100 may include any suitable number of light guide segments. Accordingly, in some embodiments, the light guide assembly 100 may be formed of two or more light guide segments 102. In some embodiments, each light guide segment 102 is in direct contact with one or more adjacently-located light guide segments. In other embodiments, one or more of the light guide segments 102 is spaced apart from one or both of the adjacently-located light guide segments.

In discussing the features of the light guide segments 102 herein, reference may be made to a single light guide segment. It will be understood that such description may apply to each of the light guide segments 102 that collectively form the light guide assembly 100. That is, embodiments of the light guide assembly 100 are contemplated where each of the light guide segments 102 has the same respective feature. Although, in some embodiments, one or more of the light guide segments 102 may differ in one or more of dimension, shape, material, light extraction property, light modification property, and the like.

The light guide segment 102 is a solid article of manufacture made from, for example, polycarbonate, poly(methyl-methacrylate) (PMMA), glass, or other appropriate material. In some embodiments, the light guide segment 102 may be a multi-layer component having two or more layers that may differ in refractive index. Each light guide segment 102 includes a first major surface 104 and a second major surface 106 opposite the first major surface 104. The light guide segment 102 is configured to propagate light by total internal reflection between the first major surface 104 and the second major surface 106.

The light guide segment 102 extends in a length direction 109 between a proximal end 108 and a distal end 110 (e.g., between edge 112 and edge 114). The dimension of the major surfaces 104, 106 in the length direction 109 is greater, typically ten or more times greater, than the thickness of the light guide segment 102. The thickness is the dimension of the light guide segment 102 in a direction orthogonal to the major surfaces 104, 106. The thickness of the light guide 102 may be, for example, about 0.1 millimeters (mm) to about 10 mm. The light guide segment 102 also extends in a width direction 111 orthogonal the length direction 109 (e.g., between side edge surfaces 116, 118). Because the light guide segments collectively form the light guide assembly, in some embodiments, the width of each of the major surfaces 104, 106 in the width direction 111 may be less than the length of the major surfaces 104, 106 in the length direction 109.

As shown in FIG. 1, in some embodiments, the major surfaces 104, 106 of the light guide segment 102 are generally rectangular in shape with their length being greater than the width. The particular width and/or length of each light guide segment 102 included in the light guide assembly 100 may depend on factors such as the size of the light guide assembly 100, the curvature of the light guide assembly 100, and the like. As an example, FIG. 2 shows another exemplary embodiment of the light guide segment 102 wherein its width in the width direction 111 is greater than the width of the light guide segment 102 in the width direction 111 shown in FIG. 1. In one example, the width of the light guide segment in the width direction 111 may be about 2 inches. In other examples, the light guide segment 102 may be wider or narrower, so long as the respective widths of the light guide segments that form the light guide assembly 100 allow for a desired curvature of the light guide assembly 100. While not specifically shown, as mentioned above, the dimensions (e.g., width, length, thickness) of the respective light guide segments 102 may vary among the light guide segments 102 that make up the light guide assembly 100 (e.g., depending on the particular configuration of the light guide assembly).

At least one edge surface extends between the major surfaces 104, 106 of the light guide segment 102 in the thickness direction. The total number of edge surfaces depends on the configuration of the light guide segment 102. In the case where the light guide segment 102 is rectangular (e.g., as shown in FIGS. 1 and 2), the light guide segment has four edge surfaces 112, 114, 116, 118. In the embodiment shown, the light guide segment 102 extends in the length direction 109 between edge surface 112 at the proximal end 108 and edge surface 114 at the distal end 110; and extends in the width direction 111 between edge surface 116 and edge surface 118. In this embodiment, the edge surfaces 116 and 118 define the sides of the light guide in the width direction and may also be referred to as side edge surfaces. Other light guide segment shapes result in a corresponding number of edge surfaces. Depending on the shape of the light guide segment 102, each edge surface may be straight or curved, and adjacent edge surfaces may meet at a vertex or join in a curve. Moreover, each edge surface may include one or more straight portions connected to one or more curved portions. The edge surface through which light from the light source is input to the light guide will now be referred to as a light input edge. In some embodiments of the light guide segments 102 shown in FIGS. 1 and 2, the edge surface 112 is a light input edge. In some embodiments, the light guide 102 includes more than one light input edge. For example, in other embodiments of the light guide segments 102 shown in FIGS. 1 and 2, both the edge surface 112 and the edge surface 114 are respective light input edges. Furthermore, the one or more light input edges may be straight and/or curved.

In the embodiment shown in FIGS. 1 and 2, the major surfaces 104, 106 of the light guide segment 102 are planar. The light guide segments 102 that form the light guide assembly 100 may be arranged relative to one another in order to form a desired curvature of the light guide assembly 100. In other embodiments, at least a portion of the major surfaces 104, 106 of the light guide segment 102 are curved in one or more directions. In one example, the intersection of the light input edge 112 and one of the major surfaces 104, 106 defines a first axis, and at least a portion of the light guide segment 102 curves about an axis parallel to the first axis (e.g., the light guide segment 102 may curve about an axis parallel to the width direction 111). In another example, at least a portion of the light guide segment 102 curves about an axis orthogonal to the first axis (e.g., the light guide segment 102 may curve about an axis parallel to the length direction 109). Similar to the above-described embodiment, the light guide segments 102 that form the light guide assembly 100 may be arranged relative to one another in order to form a desired curvature of the light guide assembly 100. As mentioned above, in some embodiments, the respective light guide segments 102 that make up the light guide assembly 100 may each have the same planar or curved shape. In other embodiments, the respective light guide segments 102 that make up the light guide assembly 100 may have different respective planar or curved shapes depending on the particular configuration of the light guide assembly 100.

As shown in the embodiments of FIGS. 1 and 2, the side edge surfaces 116, 118 each extend between the proximal end 108 and the distal end 110 of the light guide segment 102. The side edge surfaces 116, 118 may be configured to allow for adjacent light guide segments 102 to be arranged in a desired manner so that the light guide assembly 100 has a given curvature (e.g., in the width direction 111). The side surface surfaces 116, 118 are configured such that the side surface 116 of one of the light guide segments is complimentary to the abutting side edge surface 118 of an adjacently-arranged light guide segment. Accordingly, even where the side surface 116 of one of the light guide segments is in contact with the abutting side edge surface 118 of an adjacent light guide segment, the adjacent light guide segments 102 may still be variably positionable relative to one another about an axis parallel to the length direction 109 so the light guide assembly 100 curves about the axis parallel to the length direction 109.

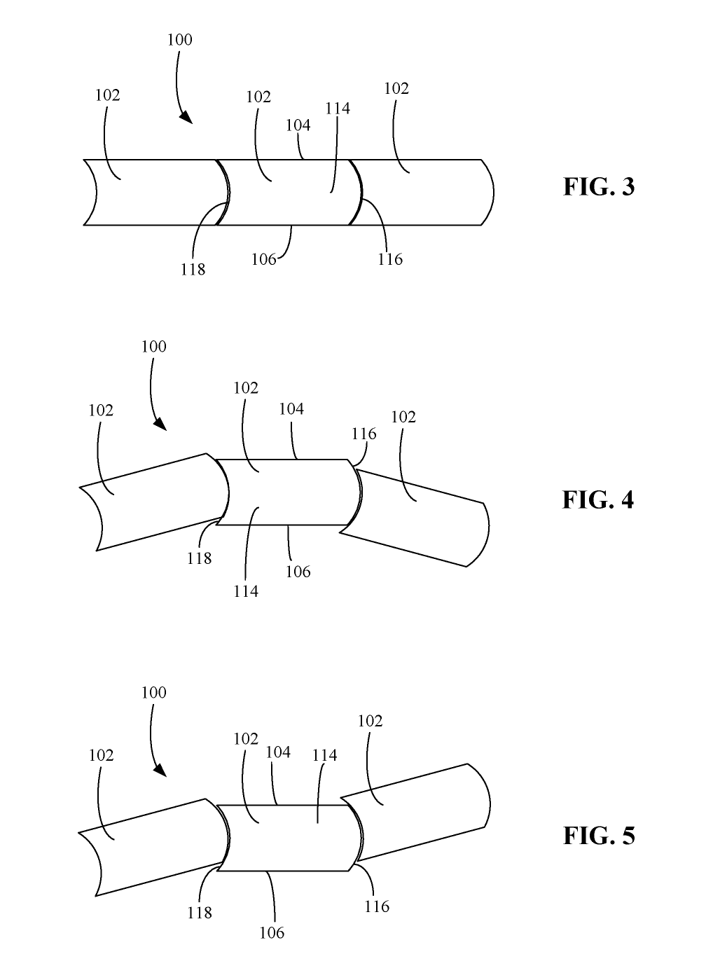

In some embodiments, one or both of the side edge surfaces 116, 118 of the light guide segment 102 includes one or more side edge surface sections that collectively form the side edge surface. At least a portion of the one or more side edge surface section is oriented non-parallel to the thickness direction. The side edge surface section(s) may be straight or curved, and adjacent edge surface sections may meet at a vertex or join in a curve. FIGS. 1 and 2 show an exemplary embodiment where the side edge surface 116 is embodied as a single side edge surface section extending between the major surfaces 104, 106, the side edge surface section being convex in shape. Also, the side edge surface 118 is embodied as a single side edge surface section extending between the major surfaces 104, 106, the side edge surface section being concave in shape. The light guide segments 102 are configured such that the convex-shaped side edge surface 116 is complimentary to the concave-shaped side edge surface 118 of the adjacent light guide segment, and adjacently-located light guide segments 102 are variably positionable relative to one another about the axis parallel to the length direction 109. FIGS. 3-5 are side views of exemplary arrangements of light guide segments 102 having the respective concave and convex side edge surfaces. In FIG. 3, the adjacently-located light guide segments 102 are arranged such that the collectively formed light guide assembly 100 is planar. In FIG. 4, the adjacently-located light guide segments 102 are arranged such that the collectively formed light guide assembly 100 is curved. In FIG. 5, the adjacently-located light guide segments are arranged such that the collectively formed light guide assembly 100 is in the form of an S-bend shape. It is noted that FIGS. 3-5 show one exemplary embodiment of respective concave and convex side edge surfaces, and that other embodiments of such side edge surface may have different shapes, e.g., different curvatures. While the adjacently-located light guide segments 102 may be arranged in the manner shown in FIGS. 3-5, it will be appreciated that the curvature between light guide segments shown therein is for illustrative purposes, and that the amount of curvature between adjacently-located light guide segments and/or the specific orientation of the adjacently-located light guide segments when placed at such curved arrangement may be different in other embodiments.

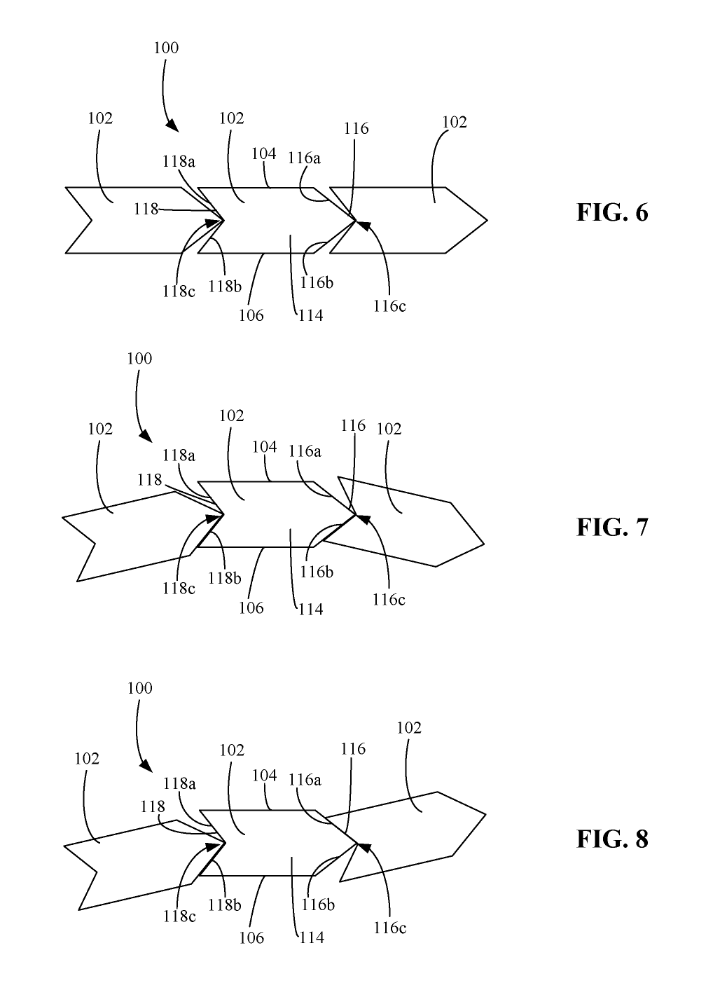

In other embodiments, the respective side edge surfaces of the light guide segments 102 may have other suitable complimentary shapes that allow for adjacently-arranged light guide segments to be variably positionable relative to one another about an axis parallel to the length direction 109 so the light guide assembly curves about the axis parallel to the length direction. As an example, FIGS. 6-8 show side views of an embodiment where one of the side edge surfaces 116 is shaped as a prismatic element having two planar side edge surface sections 116a, 116b oriented at respective angles relative to the major surfaces 104, 106 that intersect to form a ridge 116c. The other of the side edge surfaces 118 is shaped complimentary to the prismatic shape in the shape of a v-groove, wherein the side edge surface sections 118a, 118b are each planar and intersect to form a ridge 118c. Similar to the embodiment described above in FIGS. 1-5, the side edge surfaces 116, 118 shown in FIGS. 6-8 extend between the proximal end and the distal end of the light guide segment 102, and the light guide segments 102 are configured such that the side edge surface 116 having the prismatic shape of one light guide segment is complimentary to the side edge surface 118 of an adjacently located light guide segment having the v-groove. The complimentary prismatic shapes formed by the side edge surfaces may allow for adjustment of the position of one light guide segment relative to the adjacent light guide segment. In the example shown in FIGS. 6-8, the angle formed by the plane surfaces 118a, 118b that form the v-groove of one light guide segment may be wider than the angle of the prismatic shape formed by the plane surfaces 116a, 116b, and the abutted complimentary surfaces may be adjusted by pivoting the prismatic shape within the v-groove. In FIG. 6, the adjacently-located light guide segments 102 are arranged such that the collectively formed light guide assembly 100 is planar. In FIG. 7, the adjacently-located light guide segments 102 are arranged such that the collectively formed light guide assembly 100 is curved. In FIG. 8, the adjacently-located light guide segments 102 are arranged such that the collectively formed light guide assembly 100 is in the form of an S-bend shape. It is noted that FIGS. 6-8 show one exemplary embodiment of a prismatic shape and groove side edge surfaces, and that other embodiments of such side edge surface may have different shapes. As an example, in some embodiments (not specifically shown), the angle formed by the plane surfaces 118a, 118b that form the v-groove of one light guide segment may be nominally the same as the angle of the prismatic shape formed by the plane surfaces 116a, 116b; and the positioning of the prismatic shape within the groove of the adjacently-located light guide segment may allow for adjustment of the adjacently-arranged light guide segments relative to one another about an axis parallel to the length direction. While the adjacently-located light guide segments 102 may be arranged in the manner shown in FIGS. 6-8, it will be appreciated that the curvature between light guide segments shown therein is for illustrative purposes, and that the amount of curvature between adjacently-located light guide segments and/or the specific orientation of the adjacently-located light guide segments when placed at such curved arrangement may be different in other embodiments.

Any other suitable complimentary shapes that allow for adjacently-arranged light guide segments to be variably positionable relative to one another about an axis parallel to the length direction 109 are contemplated. For example, although not specifically shown, one or both of the planar surfaces of the side edge surface portions shown in FIGS. 6-8 may instead be curved about an axis extending parallel to the length direction. In another example, the ridge formed by the side edge surface portions shown in FIGS. 6-8 may instead be a curved surface such as a bullnose shape. In still other examples, the side edge surfaces may have complimentary edge surfaces formed as half of an octagon, decagon, or the like. In such an embodiment, the adjacent light guide segments may be arranged at one of several preset angles depending on the number of sides provided at the side edge surface.

As mentioned above, in some embodiments, the respective light guide segments 102 that make up the light guide assembly 100 may each have the same arrangement of side edge surfaces 116, 118 such that both side edge surfaces include one or more side edge surface sections, at least a portion of the one or more side edge surface sections oriented non-parallel to the thickness direction. For example, FIGS. 1-8 show embodiments where each of the light guide segments 102 includes one side edge surface 116 embodied as a convex or prismatic shape, and also includes another side edge surface 118 embodied as a complimentary concave or prismatic shape. In other embodiments, one or more of the light guide segments may only have one side edge surface that includes one or more side edge surface sections, where at least a portion of the one or more side edge surface sections is oriented non-parallel to the thickness direction. For example, in embodiments of the light guide assembly 100 where the assembly has ends in the width direction, the light guide segments 102 located at the ends in the width direction 111 may each have one side edge surface (e.g., the end surface of the light guide assembly 100) that is planar and extends parallel to the thickness direction, or is otherwise not complimentary to a side edge surface of an adjacently-located light guide segment.

In some embodiments, the light guide segments 102 are retained in their respective orientations using a housing assembly (described below). Adjacent light guide segments 102 may be in direct contact with each other via their respective side edge surfaces, or may be spaced apart from one another. In some embodiments, the adjacent light guide segments may be coupled to one another by an adhesive and/or resin, e.g., an index matching optical adhesive resin (not shown). The adhesive and/or resin may also hold the light guide segments in a desired arrangement. In still other embodiments, one or more reflectors may be placed between the respective side edge surface of adjacently-located light guide segments. The reflector may have a shape that corresponds to the side edge surface(s) of the light guide segment(s). In some embodiments the reflector may be used alone or together with the housing assembly, adhesive, and/or resin to retain the light guide segments in their respective orientations.

With continued reference to FIG. 1, in some embodiments the light guide segment 102 includes light extracting elements 120 in, on, or beneath at least one of the major surfaces 104, 106. Light extracting elements 120 that are in, on, or beneath a major surface will be referred to as being “at” the major surface. Each light extracting element 120 functions to disrupt the total internal reflection of the light propagating in the light guide segment and incident thereon. In one embodiment, the light extracting elements 120 reflect light toward the opposing major surface so that the light exits the light guide segment 102 through the opposing major surface. Alternatively, the light extracting elements 120 transmit light through the light extracting elements 120 and out of the major surface of the light guide segment 102 having the light extracting elements 124. In another embodiment, both types of light extracting elements 120 are present. In yet another embodiment, the light extracting elements 120 reflect some of the light and refract the remainder of the light incident thereon. Therefore, the light extracting elements 120 are configured to extract light from the light guide segment 102 through one or both of the major surfaces 104, 106.

Exemplary light extracting elements 120 include features of well-defined shape, such as V-grooves and truncated V-grooves. Other exemplary light extracting elements 120 include micro-optical elements, which are features of well-defined shape that are small relative to the linear dimensions of the major surfaces 104, 106. The smaller of the length and width of a micro-optical element is less than one-tenth of the longer of the length and width (or circumference) of the light guide segment 102 and the larger of the length and width of the micro-optical element is less than one-half of the smaller of the length and width (or circumference) of the light guide segment 102. The length and width of the micro-optical element is measured in a plane parallel to the major surface 104, 106 of the light guide segment 102 for planar light guide segments or along a surface contour for non-planar light guide segment 102. Other exemplary light extracting elements 120 include features of indistinct shape or surface textures, such as printed features of indistinct shape, ink-jet printed features of indistinct shape, selectively-deposited features of indistinct shape, and features of indistinct shape wholly formed by chemical etching or laser etching.

Light extracting elements 120 of well-defined shape (e.g., the above-described grooves and micro-optical elements) are shaped to predictably reflect or refract the light propagating in the light guide segment 102. In some embodiments, at least one of the light extracting elements 120 is an indentation (depression) of well-defined shape in the major surface 104, 106. In other embodiments, at least one of the light extracting elements 124 is a protrusion of well-defined shape from the major surface 104, 106. The light extracting elements of well-defined shape have distinct surfaces on a scale larger than the surface roughness of the major surfaces 104, 106. Light extracting elements of well-defined shape exclude features of indistinct shape or surface textures, such as printed features of indistinct shape, ink-jet printed features of indistinct shape, selectively-deposited features of indistinct shape, and features of indistinct shape wholly formed by chemical etching or laser etching.

The light extracting elements 120 of well defined shape are configured to extract light in a defined intensity profile (e.g., a uniform intensity profile) and with a defined light ray angle distribution from one or both of the major surfaces 104, 106. In this disclosure, intensity profile refers to the variation of intensity with regard to position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface. Each light extracting element 120 of well defined shape includes at least one surface configured to refract or reflect light propagating in the light guide segment 102 and incident thereon such that the light is extracted from the light guide segment. Such surface(s) is also herein referred to as a light-redirecting surface.

The light extracting elements 120 of well defined shape can be any suitable shape. As an example, the light guide segment 102 shown in FIG. 1 includes micro-optical elements at the major surface 106 configured as v-groove-shaped depressions having an arcuate ridge, hereinafter referred to as “football-shaped” micro-optical elements. A football-shaped micro-optical element resembles the profile of the ball used in American football. Each football-shaped micro-optical element 120 includes a first side edge surface 122 and a second side edge surface 124 that come together to form a ridge 126 having ends that intersect the one of the major surfaces 104, 106 at which the micro-optical element 120 is formed. Other exemplary embodiments of the light guide 102 may include micro-optical elements 120 having other suitable shapes. Exemplary micro-optical elements 120 are described in U.S. Pat. No. 6,752,505, the entire content of which is incorporated by reference, and, for the sake of brevity, are not described in detail in this disclosure.

In some embodiments, the light extracting elements 120 of well defined shape have the same or nominally the same shape, size, depth, height, slope angle, included angle, surface roughness, and/or index of refraction. The term “nominally” as used herein encompasses variations of one or more parameters that fall within acceptable tolerances in design and/or manufacture. As an example, each of the micro-optical elements 120 may have the same or nominally the same football shape shown in FIG. 1. In other embodiments, the light extracting elements 120 of well defined shape may vary in one or more of shape, size, depth, height, slope angle, included angle, surface roughness, and/or index of refraction. This variation in light extracting elements 120 of well defined shape may achieve a desired light output from the light guide over the corresponding major surface(s).

In some embodiments, the respective light guide segments 102 that make up the light guide assembly 100 may each have the same or nominally the same type and/or arrangement of light extracting elements. In other embodiments, the presence/absence of light extracting elements, as well as the shape, size, depth, height, slope angle, included angle, surface roughness, and/or index of refraction of the light extracting elements may vary from among the light guide segments that form the light guide assembly. As an example, with reference to FIG. 1, the light guide assembly may include an alternating arrangement of light guide segments where one light guide segment includes light extracting elements at its major surface(s) and the adjacently-located light guide segment does not include light extracting elements. The light guide assembly may also include reflectors respectively located between adjacent light guide segments such that light does not cross from one light guide segment to another when propagating in the light guide. Such an arrangement may provide a light guide assembly that when illuminated provides a desired visual effect. Other embodiments of the light guide assembly may have different arrangements of light extracting elements to provide a desired light output (and/or a desired visual effect).

Light guide segments 102 are typically formed by a process such as injection molding or extruding. With regard to light extracting elements, in some embodiments, light extracting elements are defined in a shim or insert used for injection molding the light guide segment by a process such as diamond machining, laser micromachining, photolithography, or another suitable process; or any of the above-mentioned processes may be used to define the light extracting elements in a master that is used to make the shim or insert. In other embodiments, the light extracting elements are subsequently formed on one or both of the major surfaces of the light guide segment by a process such as stamping, embossing, or another suitable process. With regard to the side edge surfaces of the light guide segments as described above, in some embodiments, the mold from which the light guide segment is formed is configured to form the side edge surfaces having the desired shape. In other embodiments, the side edge surfaces are formed by a secondary process. In one example, a light guide segment having a rectangular shape in a plane orthogonal to the thickness and parallel to the width direction is formed by injection molding, and the side edge surfaces of the segment are subsequently formed into a desired shape (e.g., using a router or other suitable machining tool).

With the increased popularity of LED lighting assemblies, there has also been an increase in the diversity of light guide shapes and sizes utilized therein. As an example, in the area of general lighting, there are many instances where it may be desired to manufacture a lighting fixture having a particular curved shape. In such embodiments, the light guide may be injection molded into the shape of a curved light guide such that the major surfaces of the light guide have a curvature (e.g., a convex shape, concave shape, cylindrical shape, wave shape, S-bend shape, V-bend shape, or any other suitable shape). However, this conventionally requires the use of design-specific tooling. In many situations, this design-specific tooling can be difficult to produce and cost prohibitive.

And conventionally it is not possible to injection mold the light guide as a flat panel (e.g., lacking or having a negligible amount of curvature) and subsequently subject it to secondary processing in order to adjust/change its curvature, as this would result in deformation of the micro-optical elements formed at the major surface(s) of the light guide. This would adversely modify and/or destroy the optical characteristic of such micro-optical elements. This is particularly the case when a significant amount of curvature is imparted over the surface of the light guide.

In accordance with an approach of the present application, and with exemplary reference to FIGS. 1-8 described above, a light guide assembly may instead be formed from a collection of two or more light guide segments 102, wherein the light guide segments 102 have side edge surfaces that are configured such that adjacently-located light guide segments 102 are variably positionable relative to one another. By using several light guide segments having either the same shape, or several light guide segments having one of a selected few number of shapes, a light guide assembly have a desired curvature can be formed. Accordingly, relatively generic tooling can be utilized to form a multitude of light guide shapes. This approach may also allow the light guide assembly to be formed into a desired curved shape without adversely affecting the optical characteristic of its micro-optical elements.

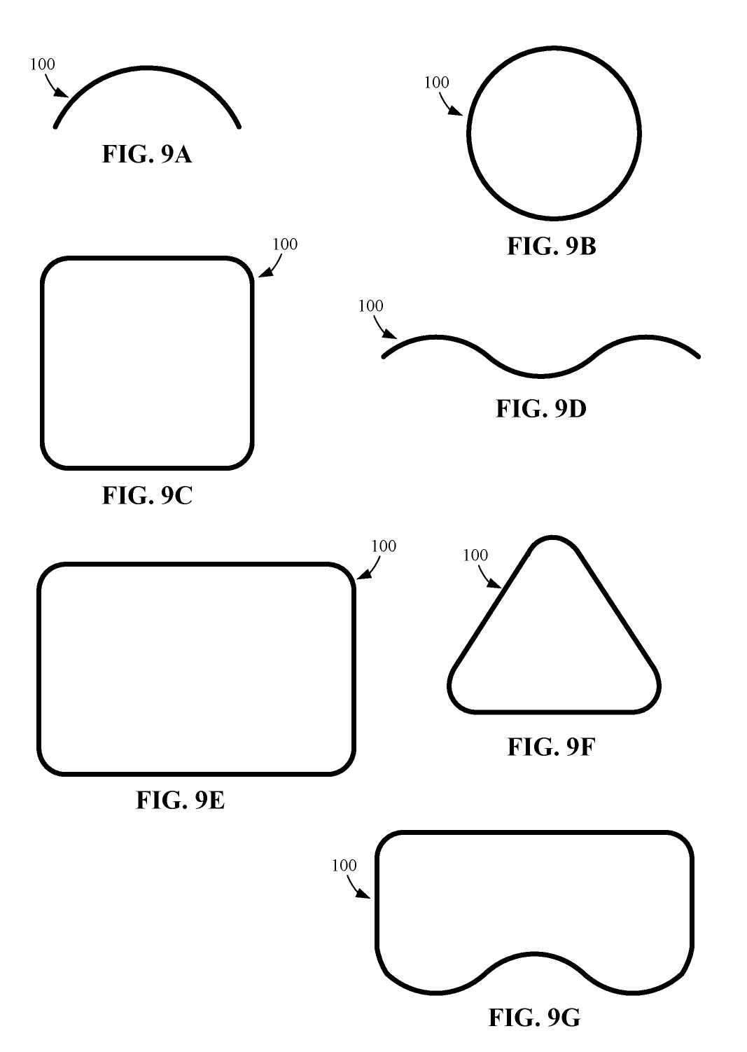

As described above, the abutting side edge surfaces of the light guide segments 102 may allow for the adjacent light guide segments 102 to be variably positionable relative to one another about an axis parallel to the length direction 109 so the light guide assembly 100 curves about the axis parallel to the length direction 109 in a desired arrangement. FIGS. 9A-9G show exemplary arrangements of such light guide assemblies. FIG. 9A shows a light guide assembly in the form of a curved convex or concave shape. FIG. 9B shows a light guide assembly in the form of a cylindrical shape. FIG. 9C shows a light guide assembly in the form of a square having rounded corners. FIG. 9D shows a light guide assembly in the form of a S-bend or “wave” shape. FIG. 9E shows a light guide assembly in the form of a rectangle having rounded corners. FIG. 9F shows a light guide assembly in the form of a triangle having rounded corners. FIG. 9G shows a light guide assembly having a combination of a rectangular and a wave shape. By utilizing the light guide segments, any other suitable arrangement may be achieved.

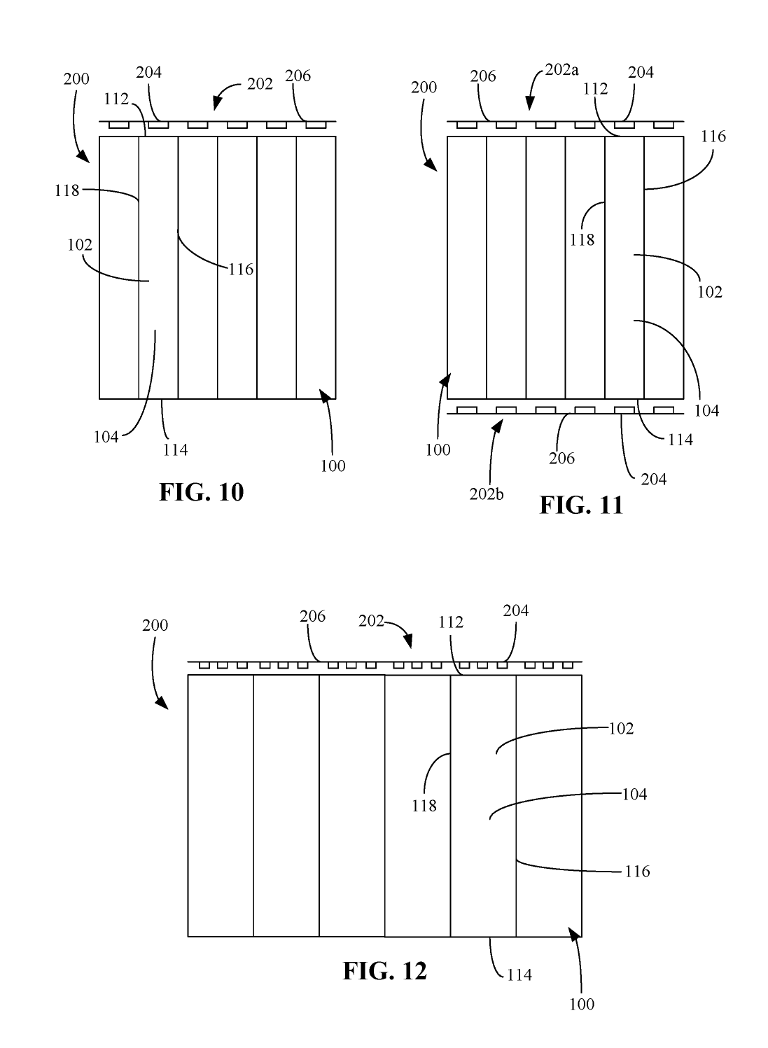

With additional reference to FIGS. 10-12, the light guide assembly may be included as part of a lighting assembly 200. As shown, the lighting assembly includes a light source 202 located adjacent to the respective light input edges of the light guide segments 102.

The light source 202 is configured to edge light the light guide segment 102 such that light from the light source 202 enters the light input edge and propagates along the light guide segment 102 by total internal reflection at the major surfaces 104, 106. In embodiments where the light guide segment 102 includes more than one light input edge, the lighting assembly 100 may include a corresponding number of light sources 202. As shown for example in FIG. 11, the lighting assembly 200 may include a first light source 202a adjacent the light input edge 112, and a second light source 202b adjacent the light input edge 114. The first and second light sources 112a, 112b may be collectively referred to as light source 112.

The light source 202 includes one or more solid-state light emitters 204. The solid-state light emitters 204 constituting the light source 202 are arranged linearly or in another suitable pattern depending on the shape of the light input edge of the light guide segment 102 to which the light source 202 supplies light. Exemplary solid-state light emitters 204 include such devices as LEDs, laser diodes, and organic LEDs (OLEDs). In an embodiment where the solid-state light emitters 204 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 204 emit light with no operably-effective intensity at wavelengths greater than 500 nanometers (nm) (i.e., the solid-state light emitters 204 emit light at wavelengths that are predominantly less than 500 nm). In some embodiments, the solid-state light emitters 204 constituting light source 202 all generate light having the same nominal spectrum. In other embodiments, at least some of the solid-state light emitters 204 constituting light source 202 generate light that differs in spectrum from the light generated by the remaining solid-state light emitters 204. For example, two different types of solid-state light emitters 204 may be alternately located along the light source 202.

The number of solid-state light emitters adjacent the light input edge of a given light guide segment 102 may be at least in part dependent on the dimensions of the light guide segment and/or the dimensions and spacing of the solid-state light emitter 204. For example, FIG. 10 shows an example where one sold-state light emitter 204 is adjacent the light input edge 112 for a given light guide segment. FIG. 12 shows another example where the width of the light guide segments is greater than the width shown in FIG. 10, and where more than one solid-state light emitter 204 is adjacent each light input edge 112 of each light guide segment 102.

The lighting assembly 200 may include one or more additional components. For example, although not specifically shown, in some embodiments of the lighting assembly, the light source includes structural components to retain the solid-state light emitters. In the examples shown in FIGS. 10-12, the solid-state light emitters 204 are mounted to a printed circuit board (PCB) 206. The light source 202 may additionally include circuitry, power supply, electronics for controlling and driving the solid-state light emitters 204, and/or any other appropriate components.

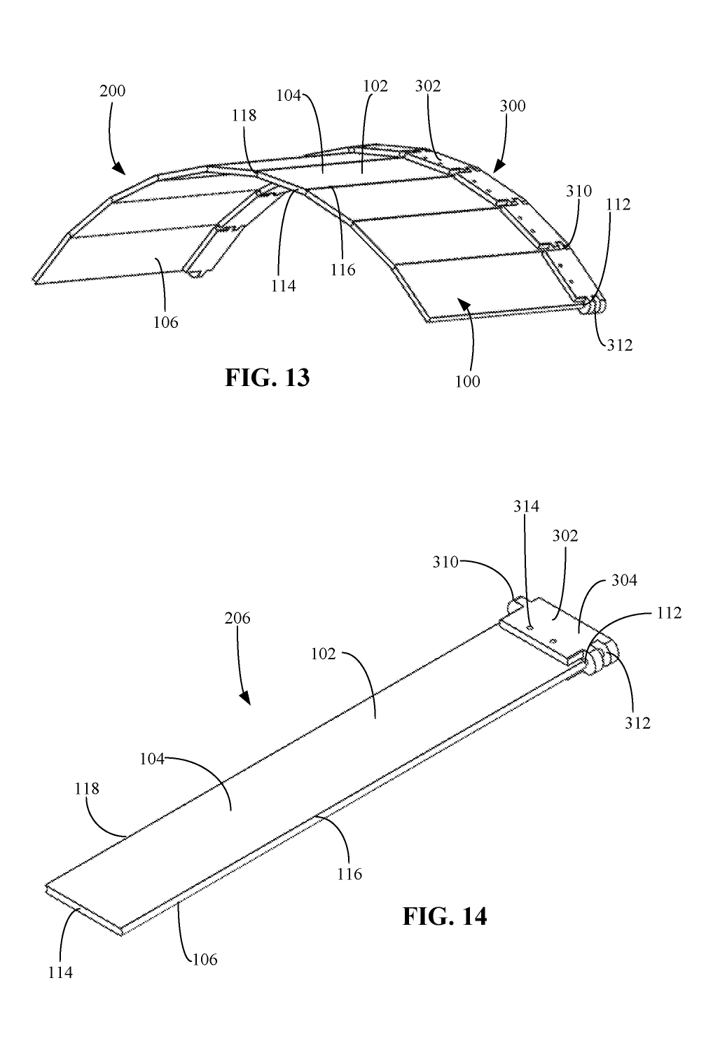

The lighting assembly 200 may additionally include a housing for retaining the light source and the light guide assembly. The housing may retain a heat sink or may itself function as a heat sink. With additional reference to FIGS. 13-16, the lighting assembly 200 includes a housing embodied as a housing assembly 300 having housing segments 302. In some embodiments, each housing segment 302 is associated with a respective light guide segment 102 and is located at the light input edge of the light guide segment (e.g., at the edge surface 112 as shown in the exemplary embodiment of FIG. 13).

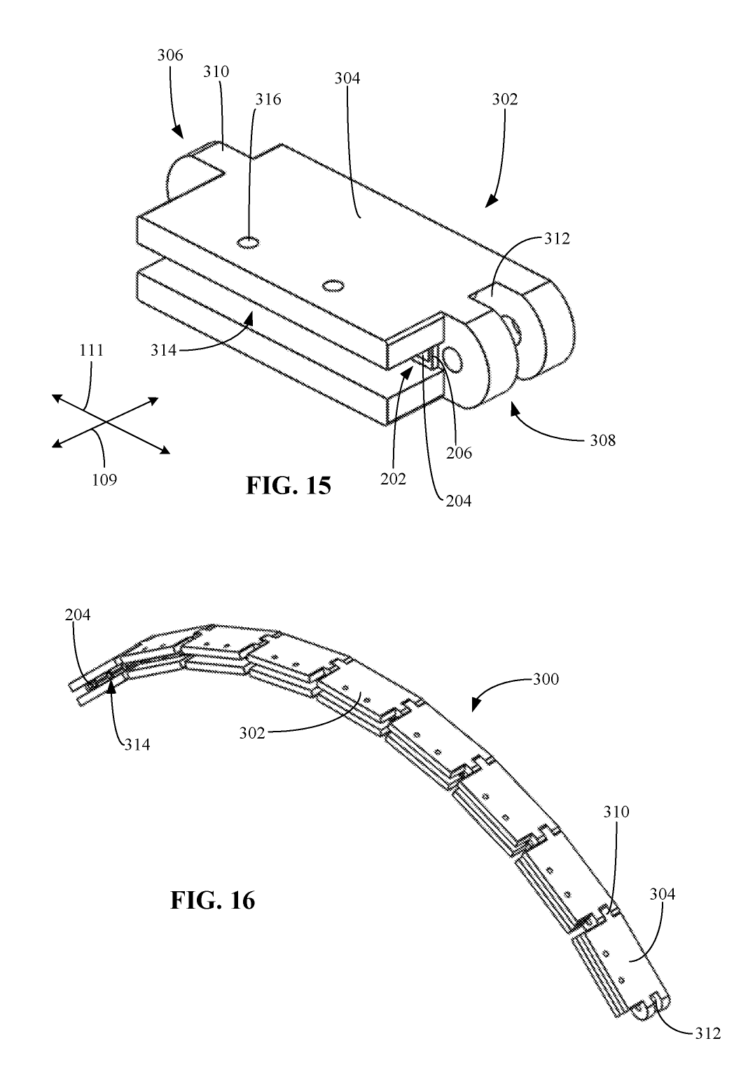

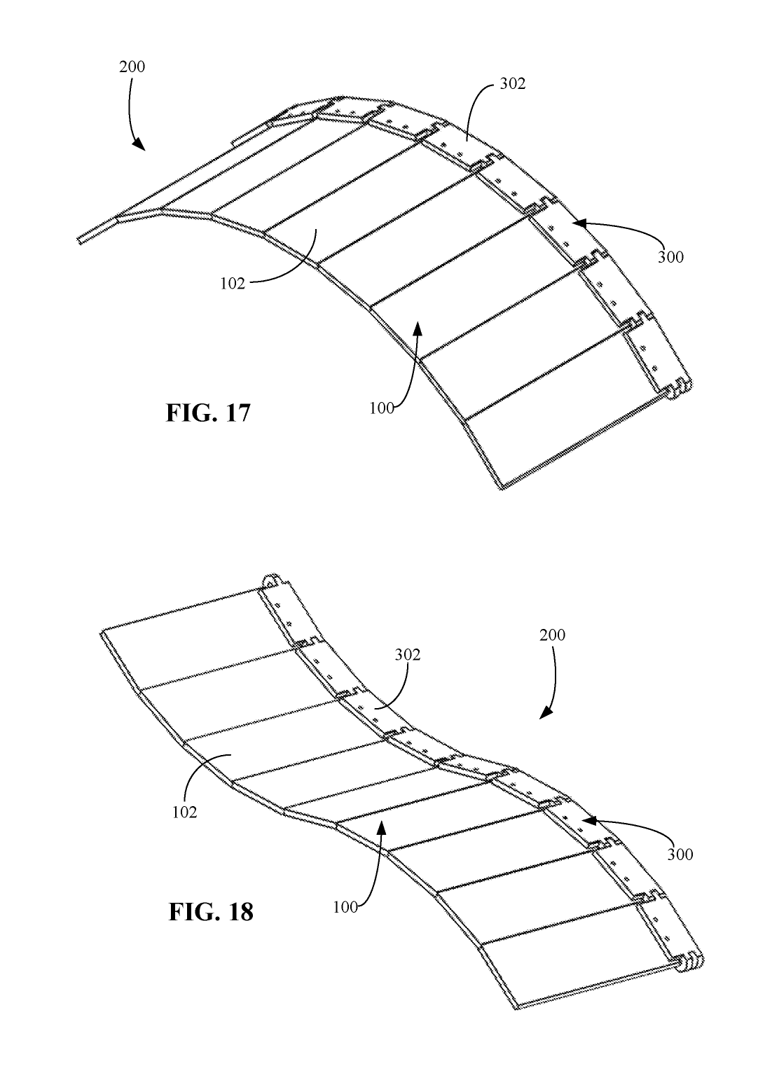

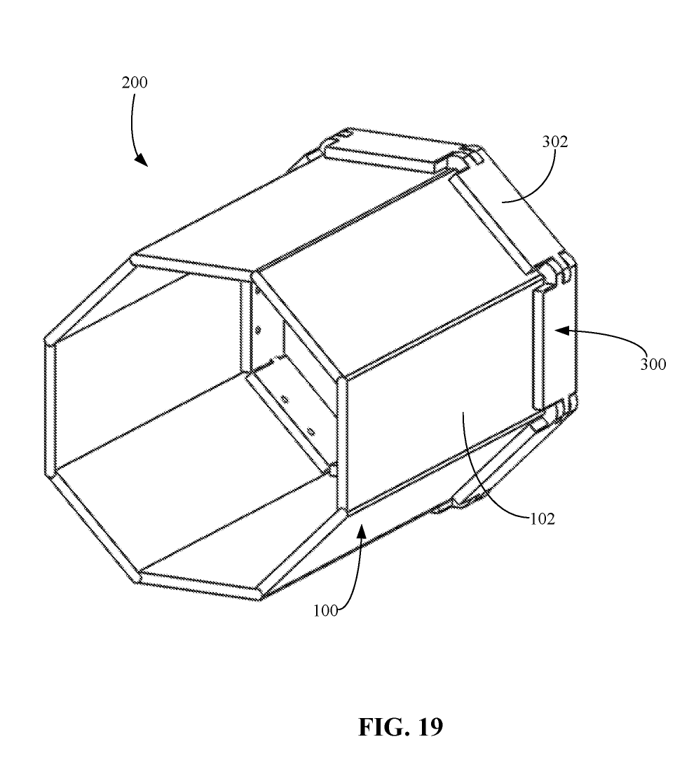

FIG. 14 shows a single instance of a light guide segment 102 retained by a single instance of a housing segment 302, which may be referred to as a lighting assembly segment 206. The housing segments 302 may be connected to one another and oriented such that the lighting assembly segments 206 that form the lighting assembly are arranged and retained in a particular arrangement. Collectively, the housing segments 302 may retain the light guide assembly 100 in a desired arrangement. Any suitable number of lighting assembly segments 206 may be coupled together to form the lighting assembly 200.

In discussing the features of the housing segments 302, reference may be made to a single housing segment. It will be understood that such description may apply to each of the housing segments 302 that collectively form the housing assembly 300. That is, embodiments of the housing assembly 300 are contemplated where each of the housing segments 302 has the same respective feature. Although, in some embodiments, the housing segments 302 may differ in one or more of dimension, shape, material, and the like.

With specific reference to FIG. 15, the housing segment 302 includes a main body portion 304 that extends in the width direction 111 between a first end 306 and a second end 308. The housing segment 302 includes coupling member 310 at its first end 306, and includes coupling member 312 at its second end 308. The coupling members 310, 312 are configured to directly couple adjacent housing segments 302 to one another. In the example shown, the coupling members 310, 312 are embodied as key and slot coupling members, respectively. One of the coupling members 310 includes a single protrusion (e.g., the key), and the other of the coupling members 312 includes a plurality of protrusions spaced apart from one another in a manner that allows the single protrusion of an adjacent housing segment to be inserted therein (e.g., the slot). As specifically shown in FIGS. 13 and 15, the coupling members of the housing segments 302 are arranged such that the key of one coupling member may mate with the slot of an adjacent coupling member (e.g., the single protrusion of one heat sink portion is interleaved with the plurality of protrusions of an adjacent heat sink portion).

The key and slot are oriented such that the housing segments 302 (and hence the light guide segments 102) may be adjusted and arranged in a particular arrangement relative to one another to provide a lighting assembly having a desired arrangement. For example, in the embodiments shown in FIGS. 13-16, the axis on which the interleaved coupling members 310, 312 pivot may be the same axis about which the side edge surfaces of the adjacently-located light guide segments 102 coupled to the respective housing segments 302 are variably positioned. Adjustment of two adjacently-coupled housing segments 302 results in a corresponding adjustment of the light guide segments 102.

In some embodiments, frictional force between the coupling members 310, 312 (e.g., between the key and slot) may retain the housing segments 302 in a particular arrangement once adjusted. In other examples, the coupling members 310, 312 (e.g., the key and slot) may have a through-hole that allows a fastening member such as a screw to be passed therethrough and tightened. In other examples, the particular arrangement of the housing segments 302 may be retained using one or more additional mechanical fasteners (not shown) together with the coupling members 310, 312 (e.g., the key and slot). In still other examples, the housing segments are disposed in a shroud (e.g., FIGS. 23-29) and the shroud retains the housing segments 302 and associated light guide segments 102 in a particular arrangement.

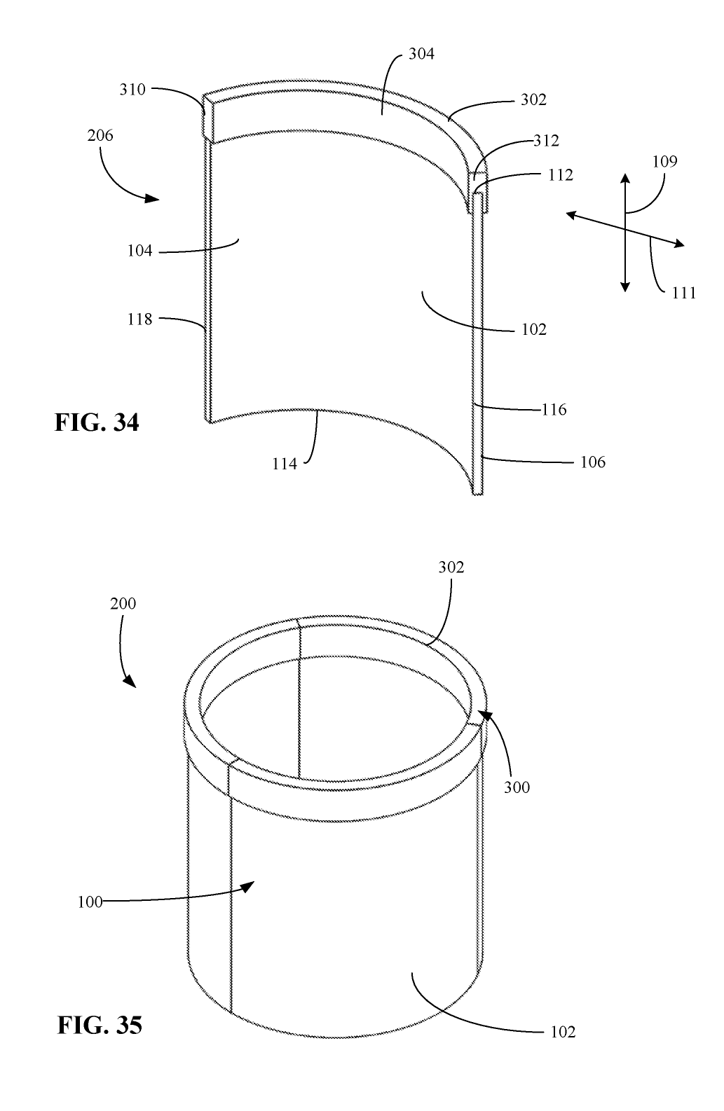

The coupling members 310, 312 may be configured in any other suitable manner that allows for the housing portion 302 to be coupled with an adjacent housing portion and adjusted to a particular arrangement. For example, in some embodiments, each coupling member may include more than one protrusion, and the respective protrusions of adjacent housing segments may be interleaved with one another. In other embodiments, the coupling members may be configured as another suitable hinge mechanism. Examples include one or more springs or a resilient material that is directly coupled to respective ends of the adjacently-located housing segments and that allows the housing segments to be variably positioned relative to one another (e.g., about the axis extending parallel to the length direction 109). In still other embodiments, the coupling members may be configured as magnetic coupling members (e.g., FIGS. 34 and 35). The magnetic couplers may couple adjacent housing portions to one another by magnetic force once the adjacent housing portions are brought together.

The housing segment includes a retaining portion 314. In the example shown, the retaining portion 314 is embodied as a channel that is configured to receive a light guide segment 102. The channel extends in the width direction 111 between the first end 306 and the second end 308 of the housing segment 302. One or more solid-state light emitters 204 (e.g., that form the light source 202 together with any additional solid-state light sources from other connected housing segments) may be retained by the housing segment 302 in the retaining portion 314. The one or more solid-state light emitters 204 may be arranged such that it is adjacent the light input edge of the light guide segment 102 when the light guide segment is retained by the housing segment (e.g., when the light guide segment is disposed in the channel). In the example shown, as retained by the housing segment 302, one of the side edge surfaces 116 of the light guide segment 102 is proximate the first end 308 of the housing segment, and the other of the side edge surfaces 118 of the light guide segment 102 is proximate the second end 306 of the housing segment. In some examples, the light guide segment 102 is mechanically fastened to the retaining portion 314. As shown in the illustrated example, the retaining portion may include one or more holes 316 through which a mechanical fastener such as a screw or pin may be inserted. In such example, the light guide segment 102 may have corresponding hole (not shown) through which the fastener may pass once the light guide segment is inserted in the channel, or the light guide may not have a corresponding hole and the fastener may instead press against the major surface of the light guide segment 102. In other embodiments, the light guide segment 102 may be fastened to the retaining portion via an adhesive, and/or may be retained by a compressive force from the walls that define the channel of the retaining portion 314.

As described above, the light source 202 may include components such as structural components to retain the solid-state light emitters, circuitry, power supply, electronics for controlling and driving the solid-state light emitters 204, and/or any other appropriate components. As the light source 202 is retained by the housing segments, the housing segment 302 may include these components. In some embodiments, the housing segments 302 may be electrically coupled to one another. In an example, the coupling members 310, 312 of the housing segment include electrical contacts for coupling electrical power to/from an adjacent housing segment. Accordingly, electrical power from a single power source may power light sources retained in multiple housing segments. In other embodiments, one or more wires may extend from the respective housing segments 302 that may be used to electrically couple the light emitters (e.g., to a power source, to a controller, and/or to one another). These wires may be covered, e.g., using a shroud (described below).

As described above, the housing segments 302 that make up the housing assembly 300 may be adjusted and/or positioned relative to one another so that the light guide segments 102 forming the lighting assembly 100 that are respectively retained by the housing segments 302 are arranged in a particular arrangement. FIGS. 17-19 show exemplary arrangements of the lighting assembly. More specifically, FIG. 17 shows one exemplary arrangement of a lighting assembly 100 in a curved, semi-cylindrical arrangement. FIG. 18 shows another exemplary arrangement of the lighting assembly 200 having a wave arrangement (an S-bend). FIG. 19 shows another exemplary arrangement of the lighting assembly 200 having a cylindrical arrangement. FIG. 19 exemplifies that the housing segments (as well as the light guide segments) allow for the ends of the lighting assembly 200 to be joined together to form a continuous shape.

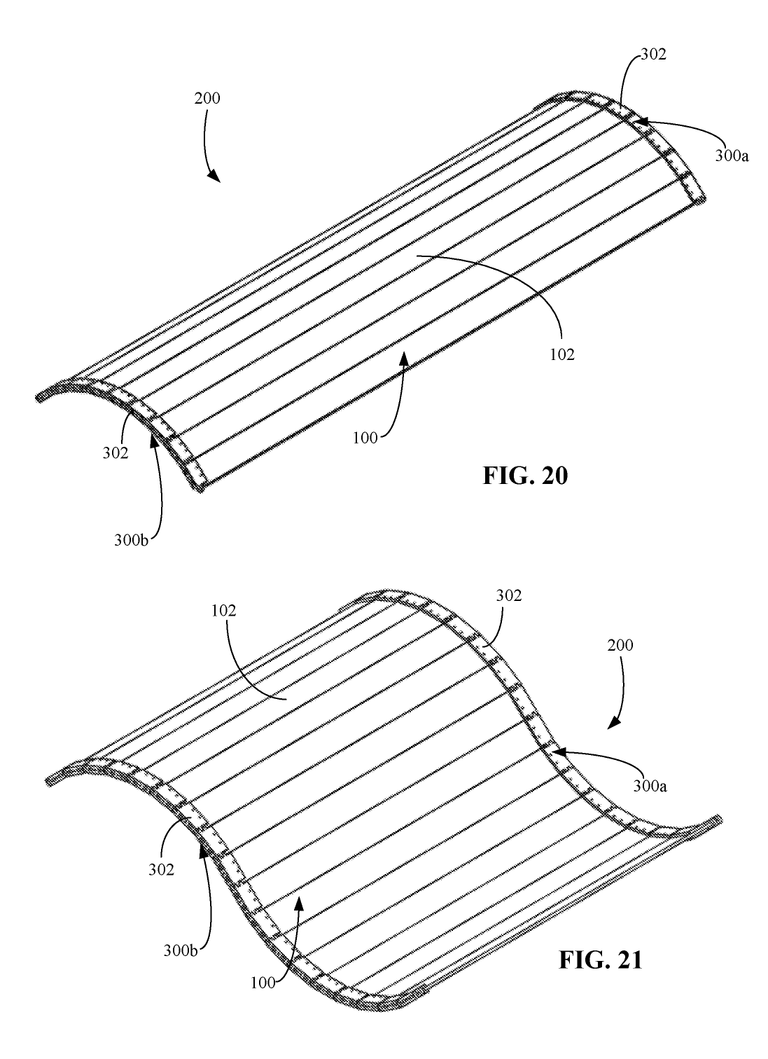

The embodiments of the lighting assembly 200 shown in FIGS. 17-19 include a housing assembly 300 at the proximal end of the light guide assembly. That is, in such embodiments, the distal end of the light guide assembly does not include a housing assembly. In other embodiments, the lighting assembly may include a plurality of housing assemblies 300, one 300a at the proximal end of the light guide assembly 100 and another 300b at the distal end of the light guide assembly 100. FIGS. 20 and 21 shows show exemplary arrangements of the lighting assembly 200 including a first housing assembly 300a at the proximal end of the light guide assembly 100 and a second housing assembly 300b at the distal end of the light guide assembly 100. FIG. 20 shows one exemplary arrangement of a lighting assembly 200 in a curved, semi-cylindrical arrangement. FIG. 21 shows another exemplary arrangement of the lighting assembly 200 having a wave arrangement (an S-bend). By including the plurality of housing assemblies, the light guide assembly can be retained from both the proximal end and the distal end thereof. The light guide segments can also be edge lit from both edge surfaces (e.g., edge surfaces 112 and 114).

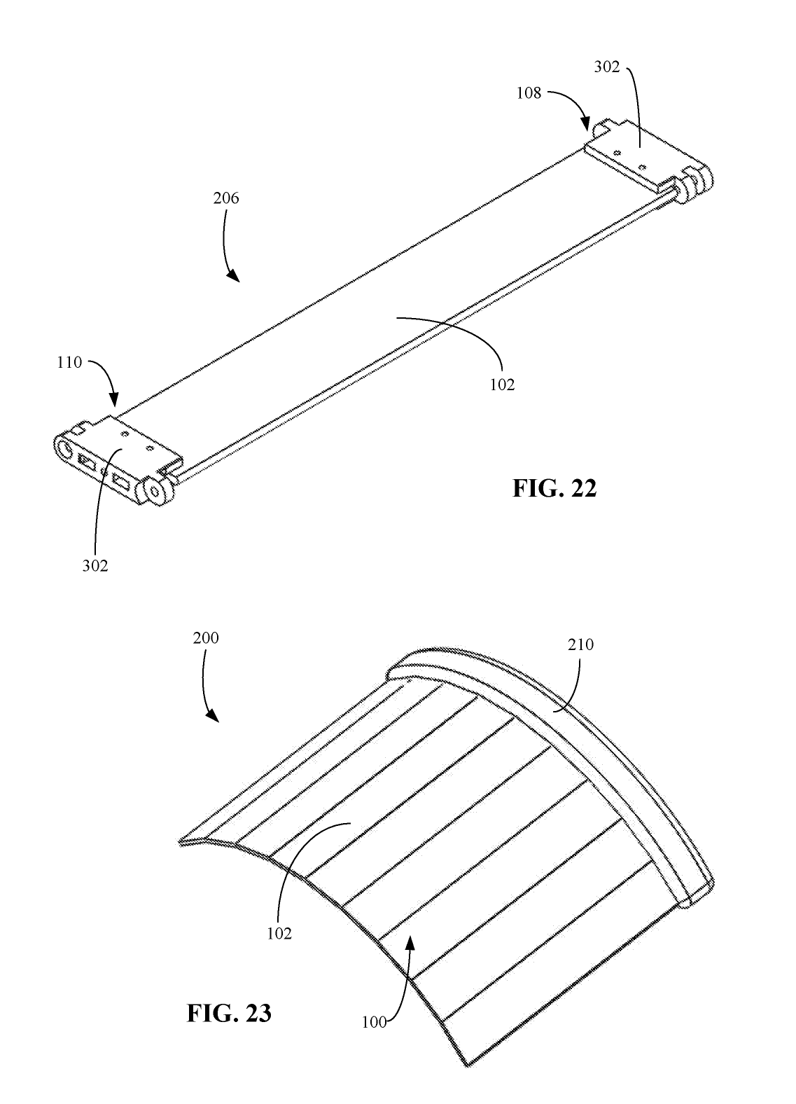

With additional reference to FIG. 22, an exemplary lighting assembly segment 206 is shown. Multiple instances of the lighting assembly segment 206 may be coupled to one another (e.g., in the manner shown in FIGS. 20 and 21) to form the lighting assembly 200. The lighting assembly segment 206 includes a light guide segment 102, a first housing segment at the proximal end 108 of the light guide segment 102, and a second housing segment at the distal end 110 of the light guide segment 102. Similar to the embodiments described above, the housing segments 302 of adjacently located lighting assembly segments 206 may be adjusted and/or positioned relative to one another so that the light guide segments 102 forming the lighting assembly 200 are arranged and retained in a particular arrangement.

In some embodiments, a shroud 210 (e.g., a bezel) may surround the housing assembly. FIGS. 23-29 show additional exemplary arrangements of the lighting assembly including a shroud 210. In some embodiments, the shroud 210 is provided for aesthetic purposes, e.g., to cover the housing segments. In other embodiments, as described above, the shroud 210 may assist in retaining the housing segments 302 in a desired arrangement. In other embodiments, the shroud 210 may assist in mounting/retaining the lighting assembly 200 to a wall, ceiling, or other structure.

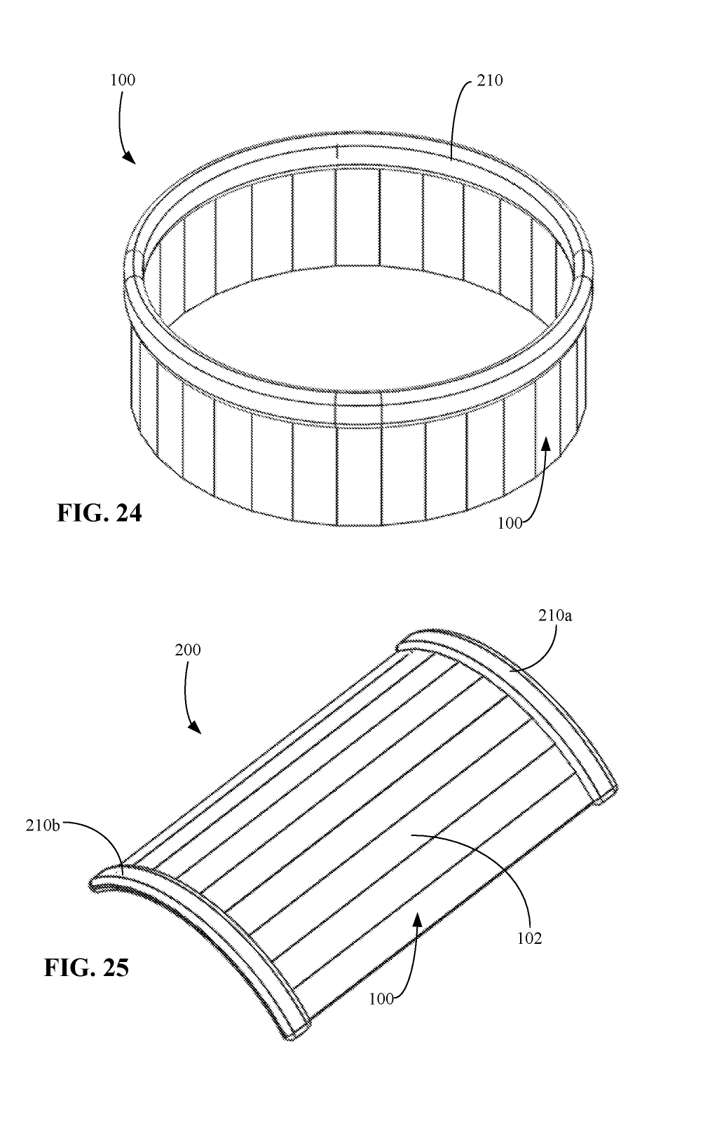

The shroud 210 may be provided in any suitable arrangement, and the particular shape of the shroud 210 may correspond to the overall shape/curvature of the lighting assembly. FIG. 23 shows an exemplary arrangement of a lighting assembly 200 in a curved, semi-cylindrical arrangement, where the shroud is also provided in a curved, semi-cylindrical arrangement surrounding the housing assembly. FIG. 24 shows an exemplary arrangement of a lighting assembly 200 having a cylindrical arrangement, where the shroud is also provided in a cylindrical shape surrounding the housing assembly. In other embodiments, the shape of the shroud 210 may correspond to the curvature of the housing assembly. In each of the embodiments, the shroud 210 may cover the housing assembly 300 but allow for the light guide assembly 100 to be exposed in its desired arrangement. In some embodiments, the shroud 210 may function as a heat sink.

In some embodiments, the lighting assembly may include more than one shroud. As an example, FIG. 25 shows an exemplary embodiment of the lighting assembly 200 similar to the embodiment shown in FIG. 20. The embodiment shown in FIG. 25 includes two shrouds 210a, 210b, each shroud associated with a respective one of the housing assemblies.

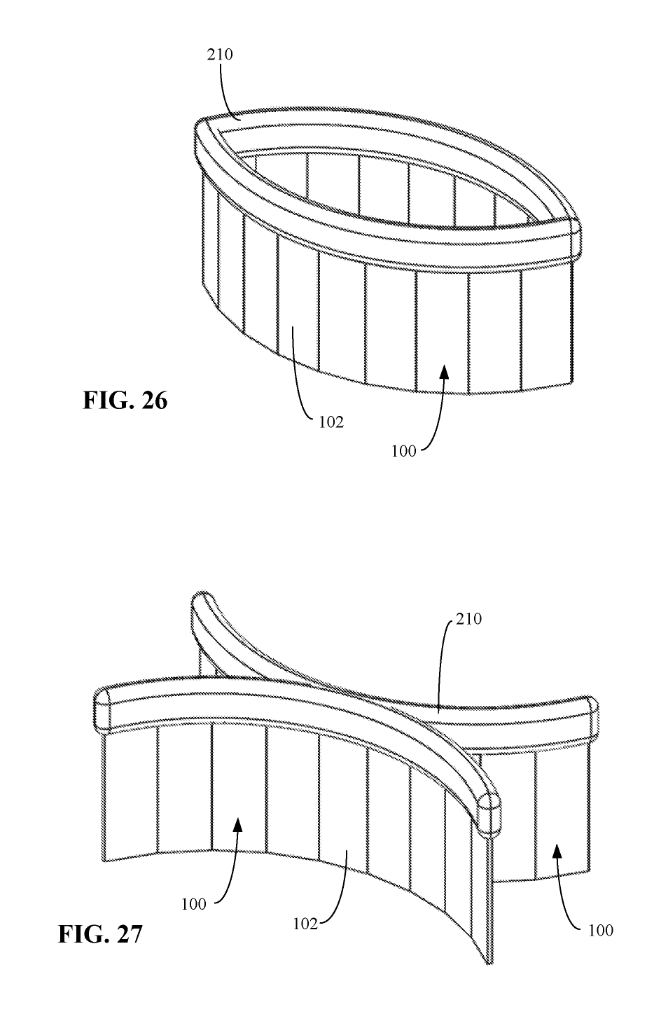

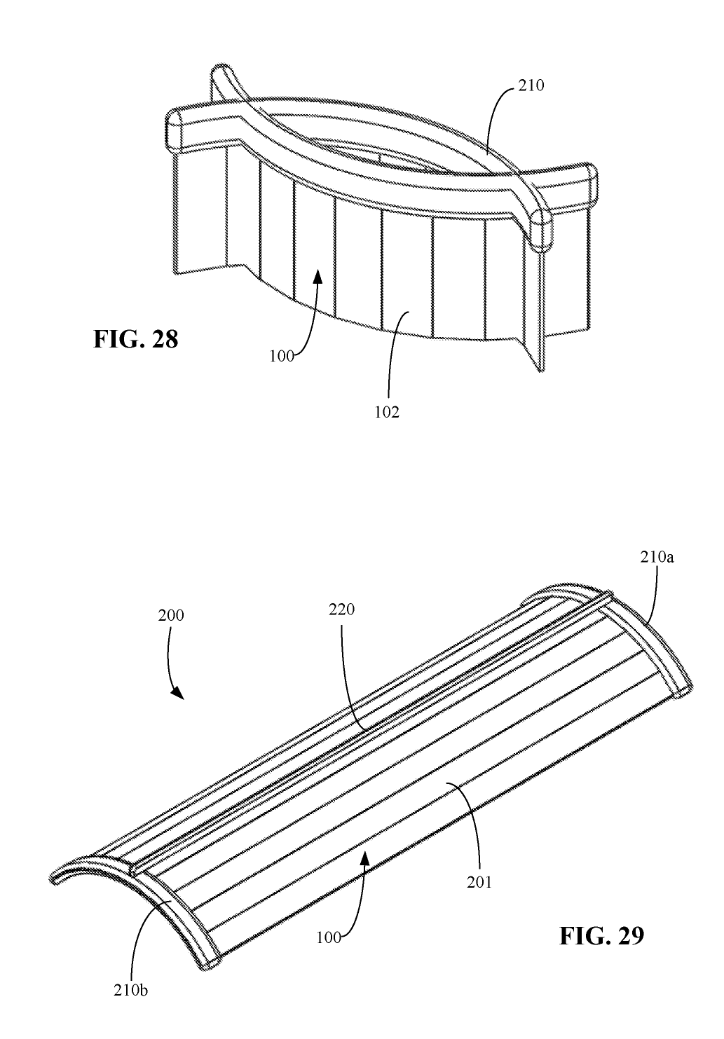

In some embodiments, a single shroud may retain more than one lighting assembly. FIG. 26 shows an exemplary embodiment in which the assembly is provided in an elliptical arrangement (e.g., a football shape). In some embodiments, a single lighting assembly may be arranged in this elliptical shape. But in other embodiments, two lighting assemblies may be curved and retained relative to one another to form the overall elliptical shape. In either of these situations, the shroud 210 may retain the lighting assembly or lighting assemblies in the desired elliptical arrangement. For example, when two lighting assemblies are used, the shroud 210 may retain both of the lighting assemblies such that the elliptical arrangement is formed. FIG. 27 shows another exemplary embodiment in which the shroud 210 retains two lighting assemblies arranged in opposing curved, semi-cylindrical arrangements. FIG. 28 shows another exemplary embodiment in which the arrangement of light guide segments 102, whether coupled together as single light guide assembly, or provided as two or more light guide assemblies, may be retained by shroud 210.

While in some embodiments the housing segments 302 (and lighting assembly segments) may be coupled in series (e.g., one coupling member of one housing segment directly coupled to one coupling member of an adjacent housing segment), FIG. 28 also illustrates that in some embodiments a housing segment 302 may be coupled in parallel to more than one adjacent housing segment. For example, the coupling member at the first and/or second end of the housing segment 302 may be configured in a manner (e.g., in a key and slot arrangement or having a magnetic configuration) that allows two or more adjacent housing segments to be coupled to that respective end.

The lighting assembly 200 may include one or more additional components. For example, FIG. 29 shows an exemplary embodiment of a lighting assembly including a connecting member 220 that extends between a first shroud 210a and a second shroud 210b. The connecting member may serve as a bracket for mounting the lighting assembly to a surface, e.g., a ceiling or a wall. As an example, the lighting assembly may be hung from a ceiling using the connecting member. In other embodiments, the lighting assembly 200 includes any other suitable bracket(s), cable(s), wire(s), stand(s), and/or the like to mount the lighting assembly to a retaining structure (e.g., a ceiling, a wall, stand, etc.).

In some embodiments, the lighting assembly 200 may additionally include a reflector (not shown) adjacent one of the major surfaces 104, 106 of the light guide segments. Exemplary reflectors include full reflectors and partial reflectors. Use of the reflector may help to control the amount of light emitted, e.g., in upward and downward directions from the lighting assembly. The light extracted through the major surface adjacent the reflector may be reflected by the reflector, re-enter the light guide segment 102 at the major surface, and be output from the light guide segment 102 through the other major surface.

In the embodiments described above, the coupling members of the housing segments may be arranged such that adjacently-located and coupled housing segments (e.g., as well as the light guide segments retained by the respective housing segments) may be positioned/adjusted relative to one another about an axis parallel to the length direction 109. As exemplified in the figures described above, the respective coupling members may be embodied as key and slot coupling members oriented nominally orthogonal to the length direction. In other embodiments, the coupling members of the housing segments may be configured such that the adjacently-located and coupled housing segments may be positioned/adjusted relative to one another in a different manner. In some embodiments, such housing segments may be used together with different shaped light guide segments in order to provide a lighting assembly having a desired shape.

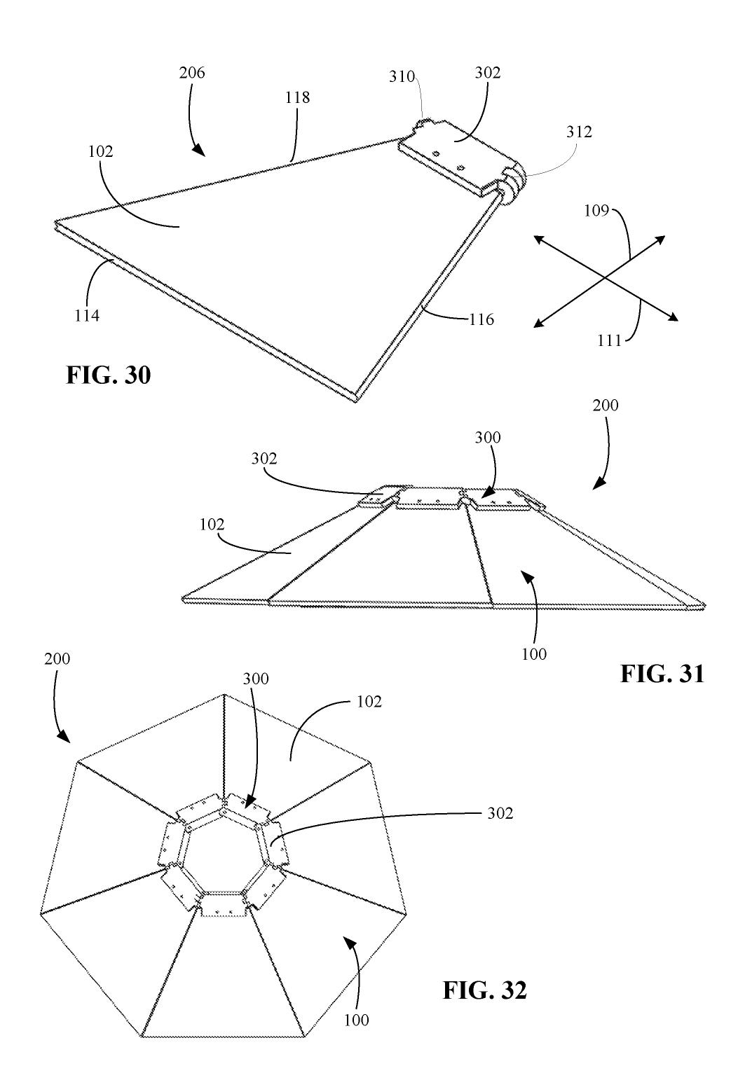

FIGS. 30-32 show an exemplary embodiment of a lighting assembly 200 where the housing segments have coupling members 310, 312 configured to couple adjacent housing segments 302 to one another, wherein the respective coupling members of the housing segments may be configured to adjust/arrange the housing portions (and the light guide segments) about an axis extending non-parallel and non-orthogonal to the length direction 109. With specific reference to FIG. 30, an exemplary embodiment of a lighting assembly segment 206 is shown including a housing segment 302 having key and the slot coupling members 310, 312 oriented at a non-parallel and non-orthogonal angle relative to the length direction 109. The light guide segment is trapezoidal in shape such that the side edge surfaces 116, 118 extend nominally orthogonal to the key and slot coupling members.

FIGS. 31 and 32 show an example in which multiple instances of the lighting assembly segment shown in FIG. 30 form the shape of a truncated cone. The axis on which the interleaved coupling members of adjacent housing segments pivot may be the same axis about which the side edge surfaces of the adjacently-located light guide segments coupled to the respective housing segments are variably positioned. Adjustment of two adjacently-coupled housing segments results in a corresponding adjustment of the light guide segments.

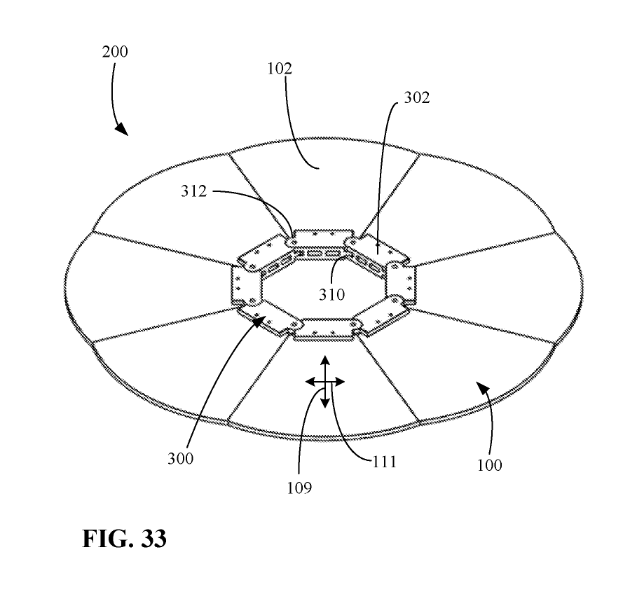

FIG. 33 shows another exemplary embodiment of a lighting assembly 200 where the housing segments include coupling members 310, 312 configured to couple adjacent housing segments 302 to one another, wherein the respective coupling members of the housing segments may be configured to adjust/arrange the housing portions (and the light guide segments) about an axis extending orthogonal to the length direction 109 and orthogonal to the width direction 111. As shown, the key and the slot coupling members 310, 312 are oriented nominally parallel to the length direction for a given lighting assembly segment 206. By adjusting the relative position of the adjacently-coupled housing segments 302, the spacing of the light guide segments 102 may be adjusted in the plane defined by the length direction 109 and width direction 111. As shown in the exemplary embodiment of FIG. 33, the relative position of the adjacently-coupled housing segments may be set such that the side edge surfaces of adjacent light guide segments are in contact with one another. In FIG. 33, the light guide assembly collectively forms an annular disk shape. The housing segments 302 can be oriented relative to one another to bring the side edge surfaces into contact with the light guide associated with an adjacent light guide and thereby create what appears as a monolithic light guide. In other embodiments, the relative position of the adjacently-coupled housing segments 302 may be set such that there is a space between the side edge surfaces of adjacent light guide segments 102. The positioning/spacing of the light guide segments may depend on factors such as the shape of the light guide segment, the relative position of the adjacently-coupled housing segments, and the like.

In some of the embodiments described above, the light guide segments 102 that form the light guide assembly 100 have planar major surfaces 104, 106, and the housing segments 302 that form the housing assembly 300 have a planar main body portion. As described above, while the surfaces of the light guide segment and housing segment may be planar, the orientation of the adjacently-located light guide segments and housing segments may be variably positionable such that the light guide assembly formed therefrom includes a curvature.

In some embodiments, one or more of the light guide segments and/or one or more of the housing segments may be curved. In some implementations, the curvature of the light guide segment and housing segment may assist in providing a desired curvature/shape to the overall lighting assembly. For example, the lighting assembly may include one or more curved lighting assembly segments and/or one or more planar lighting assembly segments, and the relative positioning of these lighting assembly segments as coupled together may form a lighting assembly having a desired curved shape. Reference is made to FIGS. 9A-9G as showing exemplary lighting assembly shapes that can be formed using a limited number of types of shapes (e.g., all planar shapes, all curved shapes, or a mixture of planar and curved shapes). This modular approach of providing a lighting assembly allows a lighting assembly of a desired shape to be more readily produced and in a more economical manner.

Expanding this modular assembly concept to other embodiments of a lighting assembly, in some implementations, the curvature of an assembled lighting assembly can be established simply by the curvature of segments themselves (e.g., absent further adjustment of the relative positioning of the adjacently-located light guide segments). The lighting assembly may include one or more curved lighting assembly segments and/or one or more planar lighting assembly segments, and adjacent housing segments may be coupled together via their respective coupling members such that the side edge surface of one light guide segment abuts and is fixed in place relative to the side edge surface of an adjacent light guide segment.

FIG. 34 shows an example of a curved lighting assembly segment 206 that exemplifies this modular concept. As shown, the major surfaces 104, 106 of the light guide segment 102 are curved about an axis extending parallel to the length direction 109. The main body portion 304 of the housing segment 302 also curves about an axis extending parallel to the length direction.

In the embodiment shown in FIG. 34, the coupling members 310, 312 are embodied as magnetic connection members. The coupling members may also provide an electric connection between adjacently connected housing segments. In other embodiments, the housing segment may have coupling members similar to those described above (e.g., key and slot coupling members). In still other embodiments, the housing segments may be retained adjacent to one another by a shroud.

In the embodiment shown in FIG. 34, the side edge surfaces 116, 118 of the light guide segment 102 are planar surfaces extending in the thickness direction between the major surfaces. With further reference to FIG. 35, which shows an exemplary embodiment of a lighting assembly 200 in the form of a cylindrical shape formed from lighting assembly segments 206 similar to those shown in FIG. 34, the adjacent housing segments 302 are coupled together and the respective side edge surfaces 116, 118 of the adjacent light guide segments 102 abut and are fixed in place relative to one another. In other embodiments, the side edge surfaces 116, 118 may include corresponding side edge surface portions similar to those described above, wherein at least a portion of the one or more side edge surface section is oriented non-parallel to the thickness direction.

In other embodiments, the lighting assembly 200 may include one or more curved lighting assembly segments and/or one or more planar lighting assembly segments, and the specific combination of these lighting assembly segments as coupled together may form the lighting assembly having a desired curved shape. Reference is again made to FIGS. 9A-9G as showing exemplary lighting assembly shapes that can be formed using a limited number of types of shapes (e.g., all planar shapes, all curved shapes, or a mixture of planar and curved shapes).

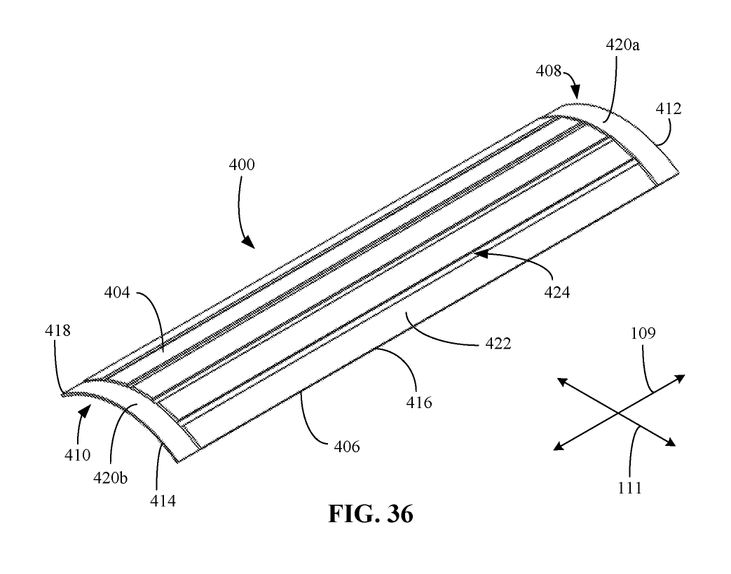

Turning now to FIG. 36, another exemplary embodiment of a light guide assembly is shown at 400. The light guide assembly 400 is a monolithic light guide that may be locally thermoformed to produce a light guide having a curved shape.

Similar to the light guide segment 102, the light guide assembly 400 is a solid article of manufacture made from, for example, polycarbonate, poly(methyl-methacrylate) (PMMA), glass, or other appropriate material. In some embodiments, the light guide assembly 400 may be a multi-layer component having two or more layers that may differ in refractive index. The light guide assembly 400 includes a first major surface 404 and a second major surface 406 opposite the first major surface 404. The light guide assembly 400 is configured to propagate light by total internal reflection between the first major surface 404 and the second major surface 406. The light guide assembly 400 extends in a length direction 109 between a proximal end 408 and a distal end 410 (e.g., between edge 412 and edge 414) along a length direction 109 of the light guide assembly 400; and extends in a width direction 111 orthogonal to the length direction 109 (e.g., between side edge surfaces 416, 418). The length and width dimensions of each of the major surfaces 404, 406 are greater, typically ten or more times greater, than the thickness of the light guide assembly 400. The thickness of the light guide assembly 400 may be, for example, about 0.1 millimeters (mm) to about 10 mm.

At least one edge surface extends between the major surfaces 404, 406 of the light guide assembly 400 in the thickness direction. The total number of edge surfaces depends on the configuration of the light guide. In the example shown, the light guide assembly is rectangular and has four edge surfaces 412, 414, 416, 418. Other light guide assembly shapes result in a corresponding number of side edge surfaces. Depending on the shape of the light guide assembly 400, each edge surface may be straight or curved, and adjacent edge surfaces may meet at a vertex or join in a curve. Moreover, each edge surface may include one or more straight portions connected to one or more curved portions. The edge surface through which light from the light source is input to the light guide will now be referred to as a light input edge. In the embodiment shown in FIG. 36, the edge surface 412 is a light input edge. In some embodiments, the light guide assembly includes more than one light input edge (e.g., edge surfaces 412 and 414). Furthermore, the one or more light input edges may be straight and/or curved.

The light guide assembly 400 includes respective transition areas 420a, 420b at the proximal end 408 and the distal end 410 of the light guide. Light guide segments 422 extend in the length direction 109 between the respective transition areas 420a, 420b, the light guide segments 422 separated by respective slots 424. As described above, the light guide assembly 400 may be a monolithic light guide, but a solid or dotted line is used in the figures in order to illustrate the respective transition areas and light guide segments. In some embodiments, the slots 424 extend fully through the light guide assembly 400 in the thickness direction of the light guide (i.e., between the major surfaces 404, 406). In other embodiments (not shown), the slots 424 extend partially through the light guide in the thickness direction. In some embodiments, the portion of the major surfaces of the light guide assembly 400 forming each light guide segment 422 is nominally planar or possesses only a slight amount of curvature, while the portion of the major surfaces of the light guide assembly forming each transition area 420a, 420b may be at least partially curved (e.g., about an axis parallel to the length direction 109).

The width of the light guide segments 422 and the width of the slots 424 are less than the width of the light guide assembly 400. In an example, each light guide segment 422 may be 2 inches, and each slot 424 may be 0.25 inches. In other examples, the light guide segments 422 and slots 424 may be wider or narrower, so long as their widths facilitate the below-described curving of the light guide assembly. In some embodiments, each light guide segment 422 has approximately the same width and each slot 424 has approximately the same width. In other embodiments, the width of the light guide segments 422 may vary and/or the width of the slots 424 may vary depending on the particular configuration of the light guide assembly.

Light extracting elements 120 (e.g., micro-optical elements) may be present at at least one of the major surfaces, more specifically at the portion of the major surface(s) that define the light guide segments. In some embodiments, light extracting elements 120 may also be included at at least one of the major surfaces in one or both of the transition areas.

The light guide assembly 400 exemplified in FIG. 36 is rectangular in shape, and has approximately a 1×4 configuration. It will be appreciated that the light guide assembly may have any other suitable geometry (e.g., 1×2, 2×2, 2×4, etc.). Furthermore, while the light guide assembly 400 shown in FIG. 36 includes two transition areas, in some embodiments, the light guide assembly 400 only includes one transition area (e.g., the light guide segments and slots may extend from the one transition area to the opposite end edge).

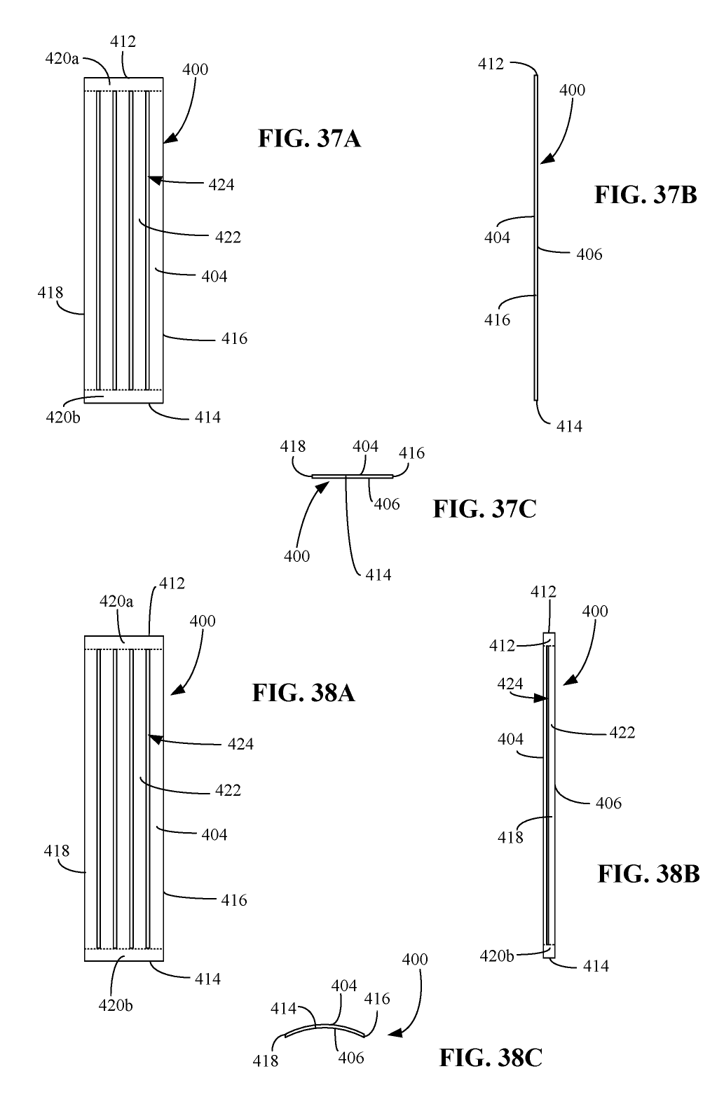

With additional reference to FIGS. 37A-37C and 38A-38C, the light guide assembly 400 may be formed by forming a planar light guide and subsequently subjecting the transition areas of the planar light guide to secondary processing. More specifically, FIG. 37A shows a top view and FIGS. 37B and 37C show respective side views of a light guide assembly 400 having planar major surfaces 404, 406. Similar to the description set forth above with respect to the light guide segment 102, the light guide assembly 400 may be formed by a process such as injection molding or extruding. The light extracting elements may be defined in a shim or insert used for injection molding the light guide segment. In some embodiments, the mold from which the light guide assembly is formed may include a pattern to allow for formation of the slots 424 and light guide segments 422 extending between the first and second transition areas 420a, 420b. In other embodiments, the light guide assembly formed via injection molding does not include the slots, and the slots are subsequently formed in the light guide assembly (e.g., using a laser or other suitable machining process). If the slots are subsequently formed in the light guide assembly, the slots may be formed prior to the below-described curving process.

FIG. 38A shows a top view and FIGS. 38B and 38C show respective side views of a light guide assembly 400 in which the transition areas 420a, 420b are curved (e.g., about an axis parallel to the length direction 109). To form the light guide assembly shown in FIGS. 38A-38C, the planar light guide is curved by subjecting the transition areas 420a, 420b to secondary processing. In an example, localized thermoforming may be performed on the transition areas 420a, 420b of the light guide assembly, during which time the transition areas 420a, 420b are formed to the desired curvature (e.g., via rolling, vacuum forming, pressing, or another suitable process). Because the widths of the light guide segments 422 are less than the width of the light guide assembly and because they are separated by the slots 424, curving the transition area 420a, 420b can be performed without curving or with curving the light guide segment only a negligible amount. Accordingly, the thermoforming process can be localized to the transition areas 420a, 420b. By localizing the thermoforming process on the transition areas 420a, 420b, the light extracting elements (e.g., micro-optical elements) present at the light guide segments 422 may not be deformed.

This formation method may allow for the use of either conventional tooling or a single configuration of tooling in order to form several configurations of curved light guide assemblies 400. For example, the light guide assembly 400 may be formed into, for example, a convex shape, concave shape, cylindrical shape, wave shape, S-bend shape, V-bend shape, or any other suitable shape. This avoids the situation where specific tooling must be created for each individual application.

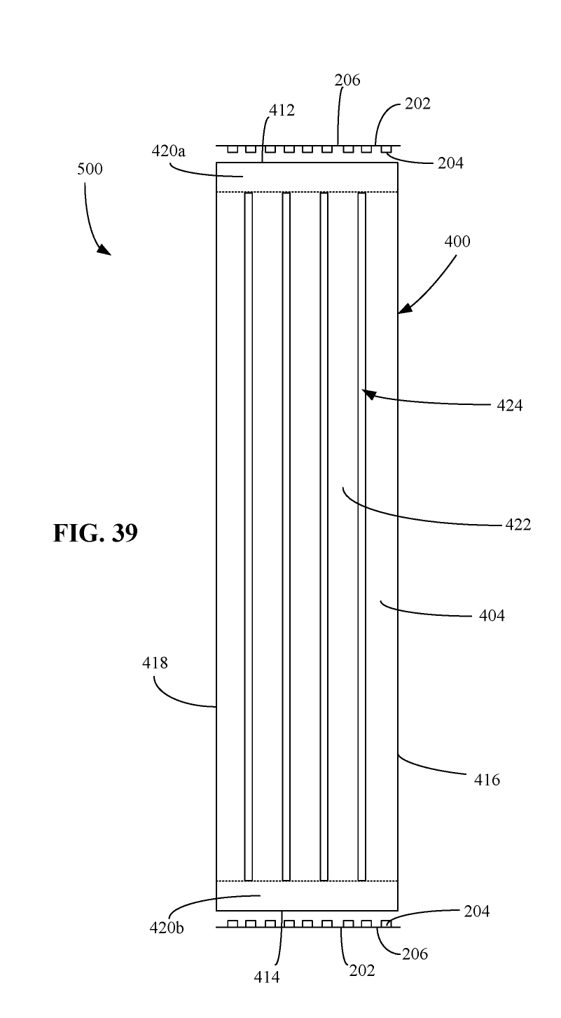

With additional reference to FIG. 39, in some embodiments, the light guide assembly 400 may be included as part of a lighting assembly 500. As shown in FIG. 39, the lighting assembly 500 may include a light source 202 positioned adjacent the light input edge. In the exemplary embodiment shown in FIG. 39, a first light source 202 is located adjacent the edge surface 412 and is configured to edge light the light guide assembly 400; and a second light source 202b is located adjacent the edge surface 414 and is configured to edge light the light guide assembly. The light source may include one or more solid-state light emitters 204 similar to that described above. The solid-state light emitters 204 constituting the light source may be arranged in a suitable pattern depending on the shape of the light input edge of the light guide to which the light source supplies light.

The lighting assembly may include one or more additional components. For example, the solid-state light emitters 204 are shown as being mounted to a printed circuit board (PCB) 206. Although not specifically shown, the light source may include circuitry, power supply, electronics for controlling and driving the solid-state light emitters, and/or any other appropriate components. The lighting assembly 500 may additionally include a housing for retaining the light source and the light guide. The housing may retain a heat sink or may itself function as a heat sink. In some embodiments, the lighting assembly includes shroud and/or a mounting mechanism (not shown) to mount the lighting assembly to a retaining structure (e.g., a ceiling, a wall, etc.).

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

What is claimed is:

1. A light guide assembly, comprising:
light guide segments, each comprising:
opposed first and second major surfaces extending between a proximal end and a distal end in a length direction, the opposed first and second major surfaces spaced apart from one another in a thickness direction orthogonal to the length direction; and
a light input edge extending in the thickness direction between the opposed first and second major surfaces at the proximal end, the first and the second major surfaces configured to propagate light input to the light guide through the light input edge therebetween by total internal reflection;
one of the light guide segments comprising a first side edge surface extending between the proximal end and distal end and between the opposed first and second major surfaces, the first side edge surface comprising one or more side edge surface sections, at least a portion of the one or more side edge surface sections oriented non-parallel to the thickness direction; and
another of the light guide segments comprising a second side edge surface complimentary to the first side edge surface and extending between the proximal end and distal end and between the opposed first and second major surfaces, the second side edge surface comprising one or more side edge surface sections, at least a portion of the one or more side edge surface sections oriented non-parallel to the thickness direction,
wherein the one of the light guide segments is arranged adjacent the another of the light guide segments such that the first side edge surface abuts the complimentary second side edge surface, the one of the light guide segments variably positionable relative to the another of the light guide segments about an axis parallel to the length direction so the light guide assembly curves about the axis parallel to the length direction.

2. The light guide assembly of claim 1, wherein
the first side edge surface is configured as a convex surface curved about an axis parallel to the length direction; and
the second side edge surface is configured as a concave surface curved about an axis parallel to the length of the light guide, the concave surface being complimentary to the convex first side edge surface.

3. The light guide assembly of claim 1, wherein
the first side edge surface is configured as a prismatic element and comprises two plane surfaces oriented at respective angles relative to the opposed first and second major surfaces that intersect to form a ridge extending in the length direction; and
the second side edge surface is configured as a v-groove, the v-groove being complimentary to the first side edge surface.

4. The light guide assembly of claim 1, wherein each of the light guide segments comprises:
a first side edge surface extending between the proximal end and distal end and between the opposed first and second major surfaces, the first side edge surface comprising one or more side edge surface sections, at least a portion of the one or more side edge surface sections oriented non-parallel to the thickness direction; and
a second side edge surface complimentary to the first side edge surface and extending between the proximal end and distal end and between the opposed first and second major surfaces, the second side edge surface comprising one or more side edge surface sections, at least a portion of the one or more side edge surface sections oriented non-parallel to the thickness direction.

5. The light guide assembly of claim 1, wherein the opposed first and second major surfaces of each of the light guide segments are planar.

6. The light guide assembly of claim 1, wherein the opposed major surfaces of at least one of the light guide segments curve about an axis parallel to the length direction.

7. A lighting assembly, comprising:
the light guide assembly of claim 1; and
a housing assembly at a proximal end of the light guide assembly, the housing assembly comprising housing segments, each housing segment associated with and retaining one of the respective light guide segments, each housing segment directly coupled to an adjacently located one of the housing segments.

8. The lighting assembly of claim 7, wherein
one of the housing segments retains the one of the light guide segments and comprises a first coupling member;
another of the housing segments retains the another of the light guide segments and comprises a second coupling member configured to directly couple to the first coupling member; and
the one of the housing segments is directly coupled to the another of the housing segments via the first and second coupling members and the one of the housing segments and the another of the housing segments are variably positionable relative to each other about the axis parallel to the length direction.

9. The lighting assembly of claim 8, wherein the first and second coupling members are respectively configured as key and slot coupling members.

10. The lighting assembly of claim 7, wherein each housing segment comprises at least one coupling member configured to couple the housing segment to an adjacent housing segment, wherein the respective coupling members of adjacent housing segments are configured as key and slot coupling members.

11. The lighting assembly of claim 7, wherein each housing segment retains a light source adjacent the light input edge of a respectively retained light guide segment, the light source configured to edge light the light guide segment.

12. A housing assembly, comprising:
housing segments, each housing segment directly coupled to an adjacently located one of the housing segments, each housing segment comprising:
a housing main body extending in a width direction between a first end and a second end;
a retaining portion configured to retain a light guide segment extending in a length direction orthogonal to the width direction; and
at least one coupling member configured to directly couple the housing segment to the adjacently located one of the housing segments;
wherein:
one of the housing segments comprises a first coupling member;
another of the housing segments comprises a second coupling member configured to directly couple to the first coupling member; and
the one of the housing segments is directly coupled to the another of the housing segments via the first and second coupling members and the one of the housing segments and the another of the housing segments are variably positionable relative to each other about an axis parallel to the length direction.

13. The housing assembly of claim 12, wherein the first and second coupling members are respectively configured as key and slot coupling members.

14. The housing assembly of claim 13, wherein the key and the slot coupling members are oriented nominally parallel to the length direction.

15. The housing assembly of claim 13, wherein the key and the slot coupling members are oriented nominally orthogonal to the length direction.

16. The housing assembly of claim 13, wherein the key and the slot coupling members are oriented at a non-parallel and non-orthogonal angle relative to the length direction.

17. The housing assembly of claim 12, wherein each housing segment comprises at least one coupling member configured to couple the housing segment to an adjacent housing segment, wherein the respective coupling members of adjacent housing segments are configured as key and slot coupling members.

18. The housing assembly of claim 12, wherein the housing main body of each housing segment is planar in the width direction.

19. The housing assembly of claim 12, wherein the housing main body of at least one of the housing segments curves about an axis parallel to the length direction.

20. The housing assembly of claim 12, wherein each housing segment retains a light source configured to edge light a light guide retained by the retaining portion.
